(19) United States
(12) Patent Application Publication
(10) Pub. No.: US 2026/0161577 A1
(43) Pub. Date: Jun. 11, 2026

(54) SEMICONDUCTOR SYSTEM CONFIGURED TO INPUT AND OUTPUT DATA

(71) Applicant: SK hynix Inc., Icheon-si Gyeonggi-do (KR)

(72) Inventors: Choung Ki SONG, Icheon-si Gyeonggi-do (KR); Jong Moo LEE, Icheon-si Gyeonggi-do (KR)

(73) Assignee: SK hynix Inc., Icheon-si Gyeonggi-do (KR)

(21) Appl. No.: 19/382,036

(22) Filed: Nov. 6, 2025

Related U.S. Application Data
(60) Provisional application No. 63/728,952, filed on Dec. 6, 2024.
(60) Provisional application No. 63/826,717, filed on Jun. 19, 2025.

(51) Int. Cl. G06F 13/16; G06F 9/30; G06F 13/40

(52) U.S. Cl. CPC G06F 13/1668; G06F 9/3001; G06F 13/4068

(57) ABSTRACT

A semiconductor system includes a control device comprising a first area and a second area, configured to generate within the first area a command and data in response to an external command and external data, and configured to output the command and the data to the second area. The semiconductor system includes a memory device vertically stacked on the second area, configured to receive the command and the data from the second area, and configured to perform an internal operation. The control device has a longer length than the memory device by the first area.

### CROSS-REFERENCE TO RELATED APPLICATION

The present application claims benefit under 35 U.S.C. § 119(e) to U.S. Provisional Application No. 63/728,952 filed on Dec. 6, 2024, and U.S. Provisional Application No. 63/826,717 filed on Jun. 19, 2025, in the United States Patent and Trademark Office, the entire contents of which applications are incorporated herein by reference.

### BACKGROUND

### 1. Technical Field

The present disclosure generally relates to a semiconductor system, and more particularly, to a semiconductor system configured to input and output data.

### 2. Related Art

Recently, stacked memory systems such as high bandwidth memory (HBM) devices are used in a wide range of applications due to their high bandwidth and energy efficiency. Unlike conventional memory systems that use parallel data buses, the stacked memory system includes a stacked memory device including a base chip and a plurality of memory chips interconnected by through silicon vias (TSVs). The stacked memory device includes a physical interface, such as a physical layer to communicate with a processor. The physical layer is designed for high-speed data transmission and efficient communication.

### SUMMARY

In an embodiment, a semiconductor system includes a control device including a first area and a second area, configured to generate within the first area a command and data in response to an external command and external data, and configured to output the command and the data to the second area and a memory device vertically stacked on the second area, configured to receive the command and the data from the second area, and configured to perform an internal operation. The control device may have a longer length than the memory device by the first area.

In an embodiment, a semiconductor system includes a control device including a first area and a second area, configured to generate within the first area a command and data in response to an external command and external data, and configured to output the command and the data to the second area, a first memory device vertically stacked on the second area and configured to perform an internal operation by receiving the command and the data from the second area, and a second memory device vertically stacked on the second area and configured to perform the internal operation by receiving the command and the data from the second area. The first memory device and the second memory device may be horizontally disposed on the second area.

In an embodiment, a semiconductor system includes a control device including a first area and a second area different from the first area, configured to generate within the first area a command and data in response to an external command and external data, and configured to output the command and the data to the second area and a memory device including a first group of channels and a second group of channels, vertically stacked on the second area, and configured to perform an internal operation through the first group of channels and the second group of channels by receiving the command and the data from the second area. The control device may have a longer length than the memory device by the first area.

In an embodiment, a semiconductor system includes a control device comprising a first base through silicon via (TSV) area and a second base TSV area disposed in a horizontal direction, configured to configured to output a command and data through the first base TSV area, and configured to output the command and the data through the second base TSV area, a first memory device comprising a first core TSV area disposed in the horizontal direction, wherein the first core TSV area receives the command and the data from the first base TSV area, and the first core TSV area outputs the data and a second memory device comprising a second core TSV area disposed in the horizontal direction, wherein the second core TSV area receives the command and the data from the second base TSV area, and the second core TSV area outputs the data.

In an embodiment, a semiconductor system includes a HBM device comprising a first physical area and a second physical area, configured to input and output first data through a first physical area, and configured to input and output second data through a second physical area, a first process circuit connected to the first physical area and configured to perform an arithmetic operation by receiving the first data and a second process circuit connected to the second physical area and configured to perform the arithmetic operation by receiving the second data, wherein the first physical area and the second physical area are disposed at a boundary of the HBM device.

In an embodiment, a semiconductor system includes a first HBM device comprising a first physical area and configured to input and output first data through the first physical area, a first process circuit configured to perform an arithmetic operation by receiving the first data through the first physical area and configured to perform the arithmetic operation by receiving second data through a second physical area, a second HBM device comprising the second physical area and a third physical area, configured to input and output the second data through the second physical area, and configured to input and output third data through the third physical area, a second process circuit configured to perform an arithmetic operation by receiving the third data through the third physical area and configured to perform the arithmetic operation by receiving fourth data through the fourth physical area and a third HBM device comprising the fourth physical area and configured to input and output the fourth data through the fourth physical area, wherein the first physical area is disposed at a boundary of the first HBM device, the second physical area and the third physical area are disposed at a boundary of the second HBM device, and the fourth physical area is disposed at a boundary of the third HBM device.

In an embodiment, a semiconductor system includes an internal interface disposed in a first direction (vertical direction), configured to receive a command and data, and configured to output the command and the data and an internal input and output line disposed in a second direction (horizontal direction), electrically connected to the internal interface, configured to receive the command and the data from the internal interface, and configured to output the command and the data, wherein the first direction and the second direction are set as an orthogonal direction.

In an embodiment, a semiconductor system includes an internal interface disposed in a first direction (vertical direction) and configured to receive and output first and second commands and first and second data, a first internal input and output line disposed in a second direction (horizontal direction), electrically connected to the internal interface, configured to receive the first command and the first data from the internal interface, and configured to output the first command and the first data and a second internal input and output line disposed in the second direction, electrically connected to the internal interface, configured to receive the second command and the second data from the internal interface, and configured to output the second command and the second data, wherein the first direction and the second direction are set as an orthogonal direction.

In an embodiment, a semiconductor system includes a first internal interface disposed in a first direction (vertical direction) and configured to receive and output first and second commands and first and second data, a first internal input and output line disposed in a second direction (horizontal direction), electrically connected to the first internal interface, configured to receive the first command and the first data from the first internal interface, and configured to output the first command and the first data, a second internal input and output line disposed in the second direction, electrically connected to the internal interface, configured to receive the second command and the second data from the internal interface, and configured to output the second command and the second data and a second internal interface disposed in the first direction, configured to generate a transfer command by receiving the second command, configured to generate transfer data by receiving the second data, and configured to output the transfer command and the transfer data to an outside of the semiconductor system.

### BRIEF DESCRIPTION OF THE DRAWINGS

FIG. 1 is a block diagram illustrating a construction of a semiconductor system according to an embodiment of the present disclosure.

FIG. 2 is a block diagram illustrating a construction of a control device according to an embodiment of the present disclosure.

FIG. 3 is a block diagram illustrating a construction of first and second memory devices according to an embodiment of the present disclosure.

FIG. 4 is a block diagram illustrating a construction of a control device according to an embodiment of the present disclosure.

FIG. 5 is a block diagram illustrating a construction of the first and second memory devices according to an embodiment of the present disclosure.

FIG. 6 is a block diagram illustrating a construction of the control device according to an embodiment of the present disclosure.

FIG. 7 is a block diagram illustrating a construction of the first and second memory devices according to an embodiment of the present disclosure.

FIG. 8 is a block diagram illustrating a construction of a semiconductor system according to an embodiment of the present disclosure.

FIGS. 9 and 10 are block diagrams illustrating constructions of semiconductor systems according to an embodiment of the present disclosure.

FIG. 11 is a block diagram illustrating a construction of an HMB device according to an embodiment of the present disclosure.

FIG. 12 is a block diagram illustrating a construction of a control device according to an embodiment of the present disclosure.

FIG. 13 is a block diagram illustrating a construction of a control device according to an embodiment of the present disclosure.

FIG. 14 is a block diagram illustrating a construction of a memory device according to an embodiment of the present disclosure.

FIG. 15 is a block diagram illustrating a construction of a control device according to an embodiment of the present disclosure.

FIG. 16 is a block diagram illustrating a construction of a control device according to an embodiment of the present disclosure.

FIG. 17 is a block diagram illustrating a construction of a memory device according to an embodiment of the present disclosure.

FIG. 18 is a block diagram illustrating a construction of a control device according to an embodiment of the present disclosure.

FIG. 19 is a block diagram illustrating a construction of a control device according to an embodiment of the present disclosure.

FIG. 20 is a block diagram illustrating a construction of a memory device according to an embodiment of the present disclosure.

### DETAILED DESCRIPTION

In the descriptions of the following embodiments, the term “preset” indicates that the numerical value of a parameter is previously decided, when the parameter is used in a process or algorithm. According to an embodiment, the numerical value of the parameter may be set when the process or algorithm is started or while the process or algorithm is performed.

Terms such as “first” and “second,” which are used to distinguish among various components, are not limited by the components. For example, a first component may be referred to as a second component, and vice versa.

When one component is referred to as being “coupled” or “connected” to another component, it should be understood that the components may be directly coupled or connected to each other or coupled or connected to each other through another component interposed therebetween. In contrast, when one component is referred to as being “directly coupled” or “directly connected” to another component, it should be understood that the components are directly coupled or connected to each other without another component interposed therebetween. When one component is referred to as being on another component, it should be understood that the components may be directly on each other or on each other through another component interposed therebetween. In contrast, when one component is referred to as being directly on another component, it should be understood that the components are directly on each other without another component interposed therebetween.

Hereafter, the present disclosure will be described in below through embodiments. The embodiments are only used to exemplify the present disclosure, and the scope of the present disclosure is not limited by the embodiments.

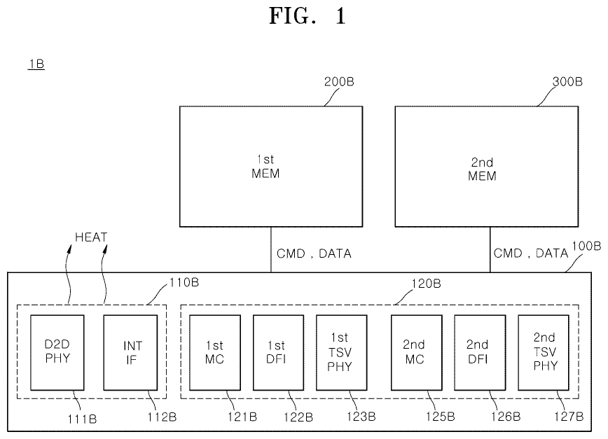

FIG. 1 is a block diagram illustrating a construction of a semiconductor system 1B according to an embodiment of the present disclosure. As illustrated in FIG. 1, the semiconductor system 1B may include a control device 100B, a first memory device (1^{st} MEM) 200B, and a second memory device (2^{nd} MEM) 300B.

The control device 100B may generate a command CMD and data DATA. The control device 100B may output the command CMD and the data DATA to the first memory device 200B and the second memory device 300B. The control device 100B may receive the data DATA from the first memory device 200B and the second memory device 300B. The control device 100B may be a base chip or a controller that controls operations of the first memory device 200B and the second memory device 300B.

The control device 100B may include a first area 110B and a second area 120B. The first area 110B may be set as an area where the command CMD and the data DATA are generated. The first area 110B may be set as an area from where heat is generated when the command CMD and the data DATA are generated. The second area 120B is an area where the command CMD and the data DATA are received from the first area 110B. The second area 120B is an area from where the command CMD and the data DATA are output and then transmitted to the first memory device 200B and the second memory device 300B. The upper part of the first area 110B may be set as a first predetermined area.

The first area 110B may include a physical area (D2D PHY) 111B and an internal interface area (INT IF) 112B.

The physical area 111B may generate the command CMD and the data DATA based on a signal that is received from an external device (e.g., various devices such as a host, a processor, and a test device). The physical area 111B may output the command CMD and the data DATA to the internal interface area 112B. The physical area 111B may be a physical layer (PHY) that is responsible for the generation, transmission, reception, and physical connection of signals and data between the external device and the control device 100B.

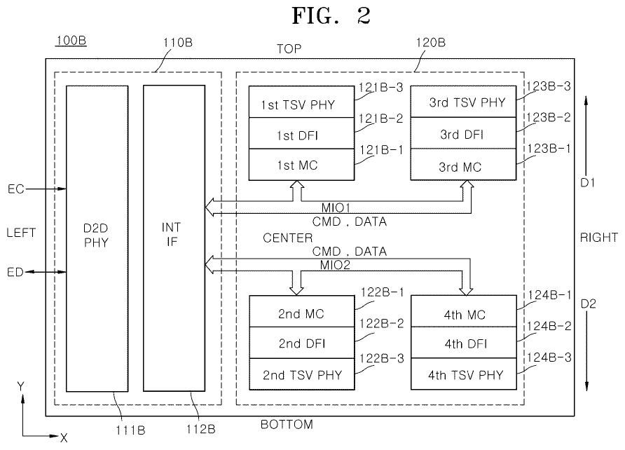

The internal interface area 112B may receive the command CMD and the data DATA from the physical area 111B. The internal interface area 112B may output the command CMD and the data DATA to internal input and output lines (MIO1 and MIO2 in FIG. 2) by adjusting the input and output sequence of the command CMD and the data DATA. The internal interface area 112B may be an interface where the timing and sequence of signals that are transmitted between a physical layer (PHY) and internal circuits are defined and the signals are input and output. The internal interface area 112B, the internal input and output lines (MIO1 and MIO2 in FIG. 2) may be implemented in a network-on-chip (NoC). The NoC may be set as a transmission path that connects various internal circuits within a chip.

The second area 120B may include a first memory controller (1^{st} MC) 121B, a first base interface area (1^{st} DFI) 122B, a first base TSV area (1^{st} TSV PHY) 123B, a second memory controller (2^{nd} MC) 125B, a second base interface area (2^{nd} DFI) 126B, and a second base TSV area (2^{nd} TSV PHY)127B.

The first memory controller 121B may receive the command CMD and the data DATA through the internal input and output lines (MIO1 and MIO2 in FIG. 2). The first memory controller 121B may output the command CMD and the data DATA that control an operation of the first memory device 200B.

The first base interface area 122B may receive the command CMD and the data DATA from the first memory controller 121B. The first base interface area 122B may output the command CMD and the data DATA to the first base TSV area 123B by adjusting the input and output sequence of the command CMD and the data DATA.

The first base TSV area 123B may receive the command CMD and the data DATA from the first base interface area 122B. The first base TSV area 123B may output the command CMD and the data DATA to the first memory device 200B through a plurality of TSVs.

The second memory controller 125B may receive the command CMD and the data DATA through the internal input and output lines (MIO1 and MIO2 in FIG. 2). The second memory controller 125B may output the command CMD and the data DATA that control an operation of the second memory device 300B.

The second base interface area 126B may receive the command CMD and the data DATA from the second memory controller 125B. The second base interface area 126B may output the command CMD and the data DATA to the second base TSV area 127B by adjusting the input and output sequence of the command CMD and the data DATA.

The second base TSV area 127B may receive the command CMD and the data DATA from the second base interface area 126B. The second base TSV area 127B may output the command CMD and the data DATA to the second memory device 300B through a plurality of TSVs.

The first memory device 200B may receive the command CMD and the data DATA from the first base TSV area 123B. The first memory device 200B may perform an internal operation based on the command CMD and the data DATA. The first memory device 200B may store the data DATA based on the command CMD after the start of a write operation. The first memory device 200B may output the data DATA that are stored based on the command CMD after the start of a read operation. The first memory device 200B may be a memory device including a plurality of core chips that are stacked.

The second memory device 300B may receive the command CMD and the data DATA from the second base TSV area 127B. The second memory device 300B may perform an internal operation based on the command CMD and the data DATA. The second memory device 300B may store the data DATA based on the command CMD after the start of a write operation. The second memory device 300B may output the data DATA that are stored after the start of a read operation based on the command CMD. The second memory device 300B may be a memory device including a plurality of core chips that are stacked.

The first memory device 200B and the second memory device 300B may be disposed on the second area 120B of the control device 100B. The first memory device 200B and the second memory device 300B may be vertically stacked on the second area 120B of the control device 100B. For example, the first memory device 200B and the second memory device 300B may be on the control device 100B through another component interposed therebetween. For example, the first memory device 200B and the second memory device 300B may be located vertically over the control device 100B, at least partially, and connected to the control device 100B through another component interposed therebetween. For example, the first memory device 200B and the second memory device 300B may be directly on the control device 100B without another component interposed therebetween. For example, the first memory device 200B and the second memory device 300B may be located vertically on the control device 100B, at least partially, without another component interposed therebetween. The first memory device 200B and the second memory device 300B may be horizontally disposed on the second area 120B of the control device 100B. The first memory device 200B and the second memory device 300B are connected to the control device 100B in common, and may input and output the data DATA having the same bandwidth. The bandwidth may be set as the amount of data that are input and output for a preset time.

The sum of the lengths of first memory device 200B and the second memory device 300B may be a length shorter than the second area 120B of the control device 100B. The control device 100B may have a length that is longer than the sum of the lengths of first memory device 200B and the second memory device 300B by the first area 110B.

As described above, the semiconductor system 1B according to an embodiment of the present disclosure can increase the bandwidth because the first memory device 200B and the second memory device 300B are connected to the control device 100B in common and input and output the data DATA. The semiconductor system 1B can prevent or mitigate heat, caused from an area in which the command CMD and the data DATA are generated, from being diffused to a memory device (e.g. 200B, 300B) because the memory device is not stacked above the area where the command CMD and the data DATA are generated.

FIG. 2 is a block diagram illustrating the construction of the control device 100B according to an embodiment of the present disclosure. As illustrated in FIG. 2, the control device 100B may include the first area 110B and the second area 120B.

The first area 110B may include the physical area 111B and the internal interface area 112B.

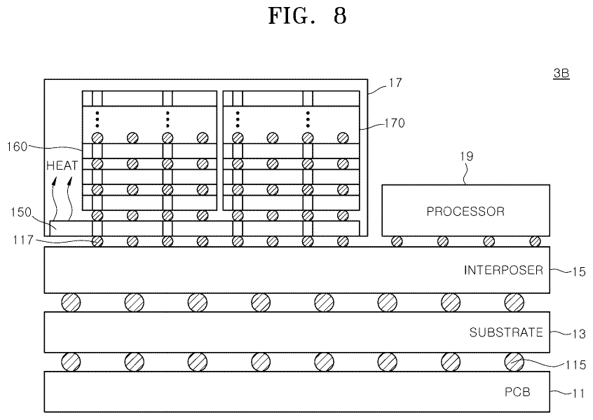

The physical area 111B may generate the command CMD by receiving an external command EC from an external device (e.g., a processor in FIG. 8). The physical area 111B may generate the command CMD by buffering or decoding the external command EC. The external command EC and the command CMD each have been illustrated as one signal, but may each include a plurality of bits. The physical area 111B may generate the data DATA by receiving external data ED from an external device (e.g., the processor in FIG. 8). The physical area 111B may generate the external data ED by receiving the data DATA from the internal interface area 112B. The physical area 111B may output the external data ED to the external device (e.g., the processor in FIG. 8). The external data ED and the data DATA each have been illustrated as one signal but may include a plurality of bits. In an embodiment, the external command EC and the external data ED are received externally from the first and second areas.

The internal interface area 112B may receive the command CMD and the data DATA from the physical area 111B. The internal interface area 112B may output the command CMD and the data DATA to the first internal input and output line MIO1 by adjusting the input and output sequence of the command CMD and the data DATA that control operations of the first memory device 200B and the second memory device 300B. The internal interface area 112B may output the command CMD and the data DATA to the second internal input and output line MIO2 by adjusting the input and output sequence of the command CMD and the data DATA that control operations of the first memory device 200B and the second memory device 300B. The first internal input and output line MIO1 and the second internal input and output line MIO2 may be disposed in a central area CENTER of the control device 100B.

The first area 110B may be set as an area where the command CMD and the data DATA are generated. The first area 110B may be set as an area where heat is generated when the command CMD and the data DATA are generated. The first area 110B may be disposed in a left area LEFT of the control device 100B in an X axis.

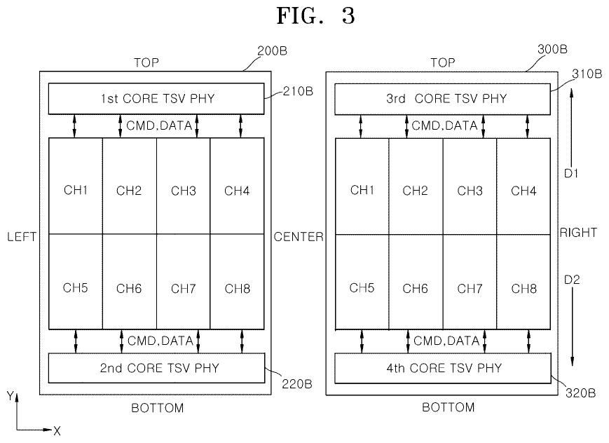

The second area 120B may include a first memory controller (1^{st} MC) 121B-1, a first base interface area (1^{st} DFI) 121B-2, a first base TSV area (1^{st} TSV PHY) 121B-3, a second memory controller (2^{nd} MC) 122B-1, a second base interface area (2^{nd} DFI) 122B-2, and a second base TSV area (2^{nd} TSV PHY) 122B-3 that control an operation of the first memory device 200B. The first memory controller 121B-1, the first base interface area 121B-2, and the first base TSV area 121B-3 may be components that control an operation of a first group of channels (CH1 to CH4 in FIG. 3) included in the first memory device 200B. The second memory controller 122B-1, the second base interface area 122B-2, and the second base TSV area 122B-3 may be components that control an operation of a second group of channels (CH5 to CH8 in FIG. 3) included in the first memory device 200B. Each of the first memory controller 121B-1, the first base interface area 121B-2, and the first base TSV area 121B-3 and the second memory controller 122B-1, the second base interface area 122B-2, and the second base TSV area 122B-3 may be the first memory controller 121B, the first base interface area 122B, and the first base TSV area 123B illustrated in FIG. 1.

The first memory controller 121B-1, the first base interface area 121B-2, and the first base TSV area 121B-3 may be arranged in the horizontal direction (i.e., X direction) of the control device 100B. The second memory controller 122B-1, the second base interface area 122B-2, and the second base TSV area 122B-3 may be arranged in the horizontal direction (i.e., X direction) of the control device 100B.

The first memory controller 121B-1 may be electrically connected to the first internal input and output line MIO1. The first memory controller 121B-1 may receive the command CMD and the data DATA that control an operation of the first group of channels (CH1 to CH4 in FIG. 3) included in the first memory device 200B through the first internal input and output line MIO1. The first memory controller 121B-1 may output the command CMD and the data DATA that control an operation of the first group of channels (CH1 to CH4 in FIG. 3) included in the first memory device 200B.

The first base interface area 121B-2 may be electrically connected to the first memory controller 121B-1. The first base interface area 121B-2 may receive the command CMD and the data DATA from the first memory controller 121B-1. The first base interface area 121B-2 may output the command CMD and the data DATA to the first base TSV area 121B-3 by adjusting the input and output sequence of the command CMD and the data DATA.

The first base TSV area 121B-3 may be electrically connected to the first base interface area 121B-2. The first base TSV area 121B-3 may receive the command CMD and the data DATA from the first base interface area 121B-2. The first base TSV area 121B-3 may output the command CMD and the data DATA to a first core TSV area (1^{st} CORE TSV PHY) (210B in FIG. 3) included in the first memory device 200B through a plurality of TSVs.

The first memory controller 121B-1, the first base interface area 121B-2, and the first base TSV area 121B-3 may be sequentially disposed in a first direction D1 from the central area CENTER of the control device 100B. The first direction D1 may be set as a direction from the central area CENTER to a first edge area TOP. The first edge area TOP may be set as an upper area of the control device 100B in a Y axis. The first edge area TOP may be placed in an outward direction from the central area CENTER.

The second memory controller 122B-1 may be electrically connected to the second internal input and output line MIO2. The second memory controller 122B-1 may receive the command CMD and the data DATA that control an operation of the second group of channels (CH5 to CH8 in FIG. 3) included in the first memory device 200B through the second internal input and output line MIO2. The second memory controller 122B-1 may output the command CMD and the data DATA that control an operation of the second group of channels (CH5 to CH8 in FIG. 3) included in the first memory device 200B.

The second base interface area 122B-2 may be electrically connected to the second memory controller 122B-1. The second base interface area 122B-2 may receive the command CMD and the data DATA from the second memory controller 122B-1. The second base interface area 122B-2 may output the command CMD and the data DATA to the second base TSV area 122B-3 by adjusting the input and output sequence of the command CMD and the data DATA.

The second base TSV area 122B-3 may be electrically connected to the second base interface area 122B-2. The second base TSV area 122B-3 may receive the command CMD and the data DATA from the second base interface area 122B-2. The second base TSV area 122B-3 may output the command CMD and the data DATA to a second core TSV area (2^{nd} CORE TSV PHY) (220B in FIG. 3) included in the first memory device 200B through a plurality of TSVs.

The second memory controller 122B-1, the second base interface area 122B-2, and the second base TSV area 122B-3 may be sequentially disposed in a second direction D2 from the central area CENTER of the control device 100B. The second direction D2 may be set as a direction from the central area CENTER to a second edge area BOTTOM. The second edge area BOTTOM may be set as a lower area of the control device 100B in the Y axis. The second edge area BOTTOM may be placed in an outward direction from the central area CENTER. The first edge area TOP and the second edge area BOTTOM may be placed in opposite directions from the central area CENTER.

The second area 120B may include a third memory controller (3^{rd} MC) 123B-1, a third base interface area (3^{rd} DFI) 123B-2, a third base TSV area (3^{rd} TSV PHY) 123B-3, a fourth memory controller (4^{th} MC) 124B-1, a fourth base interface area (4^{th} DFI) 124B-2, and a fourth base TSV area (4^{th} TSV PHY) 124B-3 that controls an operation of the second memory device 300B. The third memory controller 123B-1, the third base interface area 123B-2, and the third base TSV area 123B-3 may be components that control an operation of a first group of channels (CH1 to CH4 in FIG. 3) included in the second memory device 300B. The fourth memory controller 124B-1, the fourth base interface area 124B-2, and the fourth base TSV area 124B-3 may be components that control an operation of a second group of channels (CH5 to CH8 in FIG. 3) included in the second memory device 300B. Each of the third memory controller 123B-1, the third base interface area 123B-2, and the third base TSV area 123B-3, and the fourth memory controller 124BB-1, the fourth base interface area 124B-2, and the fourth base TSV area 124B-3 may be the second memory controller 125B, the second base interface area 126B, and the second base TSV area 127B illustrated in FIG. 1.

The third memory controller 123B-1, the third base interface area 123B-2, and the third base TSV area 123B-3 may be arranged in the horizontal direction (i.e., X direction) of the control device 100B. The fourth memory controller 124B-1, the fourth base interface area 124B-2, and the fourth base TSV area 124B-3 may be arranged in the horizontal direction (i.e., X direction) of the control device 100B.

The third memory controller 123B-1 may be electrically connected to the first internal input and output line MIO1. The third memory controller 123B-1 may receive the command CMD and the data DATA that control an operation of the first group of channels (CH1 to CH4 in FIG. 3) included in the second memory device 300B through the first internal input and output line MIO1. The third memory controller 123B-1 may output the command CMD and the data DATA that control an operation of the first group of channels (CH1 to CH4 in FIG. 3) included in the second memory device 300B.

The third base interface area 123B-2 may be electrically connected to the third memory controller 123B-1. The third base interface area 123B-2 may receive the command CMD and the data DATA from the third memory controller 123B-1. The third base interface area 123B-2 may output the command CMD and the data DATA to the third base TSV area 123B-3 by adjusting the input and output sequence of the command CMD and the data DATA.

The third base TSV area 123B-3 may be electrically connected to the third base interface area 123B-2. The third base TSV area 123B-3 may receive the command CMD and the data DATA from the third base interface area 123B-2. The third base TSV area 123B-3 may output the command CMD and the data DATA to a third core TSV area (3^{rd} CORE TSV PHY) (310B in FIG. 3) included in the second memory device 300B through a plurality of TSVs.

The third memory controller 123B-1, the third base interface area 123B-2, and the third base TSV area 123B-3 may be sequentially disposed in the first direction D1 from the central area CENTER of the control device 100B.

The fourth memory controller 124B-1 may be electrically connected to the second internal input and output line MIO2. The fourth memory controller 124B-1 may receive the command CMD and the data DATA that control an operation of the second group of channels (CH5 to CH8 in FIG. 3) included in the second memory device 300B through the second internal input and output line MIO2. The fourth memory controller 124B-1 may output the command CMD and the data DATA that control an operation of the second group of channels (CH5 to CH8 in FIG. 3) included in the second memory device 300B.

The fourth base interface area 124B-2 may be electrically connected to the fourth memory controller 124B-1. The fourth base interface area 124B-2 may receive the command CMD and the data DATA from the fourth memory controller 124B-1. The fourth base interface area 124B-2 may output the command CMD and the data DATA to the fourth base TSV area 124B-3 by adjusting the input and output sequence of the command CMD and the data DATA.

The fourth base TSV area 124B-3 may be electrically connected to the fourth base interface area 124B-2. The fourth base TSV area 124B-3 may receive the command CMD and the data DATA from the fourth base interface area 124B-2. The fourth base TSV area 124B-3 may output the command CMD and the data DATA to a fourth core TSV area (4^{th} CORE TSV PHY) (320B in FIG. 3) included in the second memory device 300 through a plurality of TSVs.

The fourth memory controller 124B-1, the fourth base interface area 124B-2, and the fourth base TSV area 124B-3 may be sequentially disposed in the second direction D2 from the central area CENTER of the control device 100B.

The second area 120B may be set as an area in which the command CMD and the data DATA are received from the first area 110B and output to the first memory device 200B and the second memory device 300B. The second area 120B may be disposed in a right area RIGHT of the control device 100B in the X axis.

FIG. 3 is a block diagram illustrating a construction of the first memory device 200B and the second memory device 300B according to an embodiment of the present disclosure.

The first memory device 200B may include first to eighth channels CH1 to CH8, the first core TSV area 210B, and the second core TSV area 220B.

The first core TSV area 210B and the second core TSV area 220B may be arranged in the horizontal direction (i.e., X direction) of the first memory device 200B.

The first to eighth channels CH1 to CH8 may receive the command CMD and the data DATA by independently performing internal operations. The first to eighth channels CH1 to CH8 may each store the data DATA based on the command CMD after the start of a write operation of an internal operation. The first to eighth channels CH1 to CH8 may each output the data DATA based on the command CMD after the start of a read operation of an internal operation.

The first to fourth channels CH1 to CH4 may be electrically connected to the first core TSV area 210B. The first to fourth channels CH1 to CH4 may receive the command CMD and the data DATA from the first core TSV area 210B. The first to fourth channels CH1 to CH4 may output the data DATA to the first core TSV area 210B. The first to fourth channels CH1 to CH4 may each store the data DATA based on the command CMD after the start of a write operation of an internal operation. The first to fourth channels CH1 to CH4 may each output the data DATA based on the command CMD after the start of a read operation of an internal operation. The first to fourth channels CH1 to CH4 may be set as the first group of channels.

The fifth to eighth channels CH5 to CH8 may be electrically connected to the second core TSV area 220B. The fifth to eighth channels CH5 to CH8 may receive a command CMD and data DATA from the second core TSV area 220B. The fifth to eighth channels CH5 to CH8 may output the data DATA to the second core TSV area 220B. The fifth to eighth channels CH5 to CH8 may each store the data DATA based on the command CMD after the start of a write operation of an internal operation. The fifth to eighth channels CH5 to CH8 may each output the data DATA based on the command CMD after the start of a read operation of an internal operation. The first to fourth channels CH1 to CH4 may be set as the first group of channels. The fifth to eighth channels CH5 to CH8 may be set as the second group of channels.

The first to fourth channels CH1 to CH4 may be disposed in the central area CENTER of the first memory device 200B. The fifth to eighth channels CH5 to CH8 may be disposed in the central area CENTER of the first memory device 200B.

The first core TSV area 210B may be electrically connected to the first base TSV area 121B-3 of the control device 100B. The first core TSV area 210B may receive the command CMD and the data DATA from the first base TSV area 121B-3. The first core TSV area 210B may receive the command CMD and the data DATA through the plurality of TSVs. The first core TSV area 210B may output the command CMD and the data DATA to the first to fourth channels CH1 to CH4. The first core TSV area 210B may receive the data DATA from the first to fourth channels CH1 to CH4 and output the data DATA to the first base TSV area 121B-3. The first core TSV area 210B may be disposed in the first direction D1 from the central area CENTER. The first direction D1 may be set as a direction from the central area CENTER to the first edge area TOP. The first edge area TOP may be set as an upper area of the first memory device 200B in the Y axis. The first edge area TOP may be placed in an outward direction from the central area CENTER.

The second core TSV area 220B may be electrically connected to the second base TSV area 122B-3 of the control device 100B. The second core TSV area 220B may receive the command CMD and the data DATA from the second base TSV area 122B-3. The second core TSV area 220B may receive the command CMD and the data DATA through the plurality of TSVs. The second core TSV area 220B may output the command CMD and the data DATA to the fifth to eighth channels CH5 to CH8. The second core TSV area 220B may receive the data DATA from the fifth to eighth channels CH5 to CH8 and output the data DATA to the second base TSV area 122B-3. The second core TSV area 220B may be disposed in the second direction D2 from the central area CENTER. The second direction D2 may be set as a direction from the central area CENTER to the second edge area BOTTOM. The second edge area BOTTOM may be set as a lower area of the first memory device 200B in the Y axis. The second edge area BOTTOM may be placed in an outward direction from the central area CENTER. The first edge area TOP and the second edge area BOTTOM may be placed in opposite directions from the central area CENTER.

The first memory device 200B may be disposed in the left area LEFT of the X axis.

The second memory device 300B may include the first to eighth channels CH1 to CH8, the third core TSV area 310B, and the fourth core TSV area 320B.

The third core TSV area 310B and the fourth core TSV area 320B may be arranged in the horizontal direction (i.e., X direction) of the second memory device 300B.

The first to eighth channels CH1 to CH8 may receive the command CMD and the data DATA by independently performing internal operations. The first to eighth channels CH1 to CH8 may each store the data DATA based on the command CMD after the start of a write operation of an internal operation. The first to eighth channels CH1 to CH8 may each output the data DATA based on the command CMD after the start of a read operation of an internal operation.

The first to fourth channels CH1 to CH4 may be electrically connected to the third core TSV area 310B. The first to fourth channels CH1 to CH4 may receive the command CMD and the data DATA from the third core TSV area 310B. The first to fourth channels CH1 to CH4 may output the data DATA to the third core TSV area 310B. The first to fourth channels CH1 to CH4 may each store the data DATA based on the command CMD after the start of a write operation of an internal operation. The first to fourth channels CH1 to CH4 may each output the data DATA based on the command CMD after the start of a read operation of an internal operation. The first to fourth channels CH1 to CH4 may be set as the first group of channels.

The fifth to eighth channels CH5 to CH8 may be electrically connected to the fourth core TSV area 320B. The fifth to eighth channels CH5 to CH8 may receive a command CMD and data DATA from the fourth core TSV area 320B. The fifth to eighth channels CH5 to CH8 may output the data DATA to the fourth core TSV area 320B. The fifth to eighth channels CH5 to CH8 may each store the data DATA based on the command CMD after the start of a write operation of an internal operation. The fifth to eighth channels CH5 to CH8 may each output the data DATA based on the command CMD after the start of a read operation of an internal operation. The fifth to eighth channels CH5 to CH8 may be set as the second group of channels.

The first to eighth channels CH1 to CH8 may be disposed in the central area CENTER of the second memory device 300B.

The third core TSV area 310B may be electrically connected to the third base TSV area 123B-3 of the control device 100B. The third core TSV area 310B may receive the command CMD and the data DATA from the third base TSV area 123B-3. The third core TSV area 310B may receive the command CMD and the data DATA through the plurality of TSVs. The third core TSV area 310B may output the command CMD and the data DATA to the first to fourth channels CH1 to CH4. The third core TSV area 310B may receive the data DATA from the first to fourth channels CH1 to CH4 and output the data DATA to the third base TSV area 123B-3. The third core TSV area 310B may be disposed in the first direction D1 from the central area CENTER.

The fourth core TSV area 320B may be electrically connected to the fourth base TSV area 124B-3 of the control device 100B. The fourth core TSV area 320B may receive the command CMD and the data DATA from the fourth base TSV area 124B-3. The fourth core TSV area 320B may receive the command CMD and the data DATA through the plurality of TSVs. The fourth core TSV area 320B may output the command CMD and the data DATA to the fifth to eighth channels CH5 to CH8. The fourth core TSV area 320B may receive the data DATA from the fifth to eighth channels CH5 to CH8 and output the data DATA to the fourth base TSV area 124B-3. The fourth core TSV area 320B may be disposed in the second direction D2 from the central area CENTER.

The second memory device 300B may be disposed in the right area RIGHT of the X axis.

As described above, the semiconductor system 1B according to an embodiment of the present disclosure can increase the bandwidth because the first memory device 200B and the second memory device 300B are connected to the control device 100B in common and input and output the data DATA. The semiconductor system 1B can prevent or reduce heat from an area in which the command CMD and the data DATA are generated from being diffused to a memory device because a memory device (e.g., 200B, 300B) is not stacked above the area in which the command CMD and the data DATA are generated.

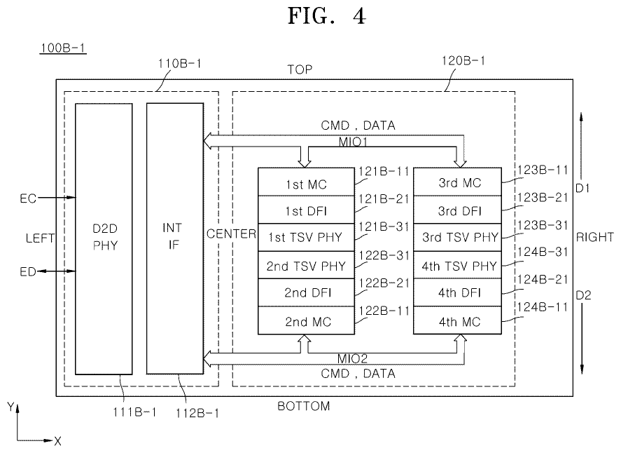

FIG. 4 is a block diagram illustrating a construction of a control device according to an embodiment of the present disclosure. In an embodiment, the control device 100B-1 represents the control device 100B illustrated in FIG. 1. As illustrated in FIG. 4, the control device 100B-1 may include a first area 110B-1 and a second area 120 B-1.

The first area 110B-1 may include a physical area (D2D PHY) 111B-1 and an internal interface area (INT IF) 112B-1.

The physical area 111B-1 may generate a command CMD based on an external command EC from an external device (e.g., the processor in FIG. 8). The physical area 111B-1 may generate the command CMD by buffering or decoding the external command EC. The external command EC and the command CMD each have been illustrated as one signal, but may each include a plurality of bits. The physical area 111B-1 may generate data DATA by receiving external data ED from an external device (e.g., the processor in FIG. 8). The physical area 111B-1 may generate the external data ED by receiving the data DATA from the internal interface area 112B-1. The external data ED and the data DATA each have been illustrated as one signal, but may each include a plurality of bits.

The internal interface area 112B-1 may receive the command CMD and the data DATA from the physical area 111B-1. The internal interface area 112B-1 may output the command CMD and the data DATA to a first internal input and output line MIO1 by adjusting the input and output sequence of the command CMD and the data DATA that control operations of a first memory device 200B-1 and a second memory device 300B-1. The internal interface area 112B-1 may output the command CMD and the data DATA to a second internal input and output line MIO2 by adjusting the input and output sequence of the command CMD and the data DATA that control operations of the first memory device 200B-1 and the second memory device 300B-1. The first internal input and output line MIO1 may be disposed in a first edge area TOP of the control device 100B-1. The second internal input and output line MIO2 may be disposed in a second edge area BOTTOM of the control device 100B-1.

The first area 110B-1 may be set as an area in which the command CMD and the data DATA are generated. The first area 110B-1 may be set as an area in which heat is generated when the command CMD and the data DATA are generated. The first area 110B-1 may be disposed in a left area LEFT of the control device 100B-1 in an X axis.

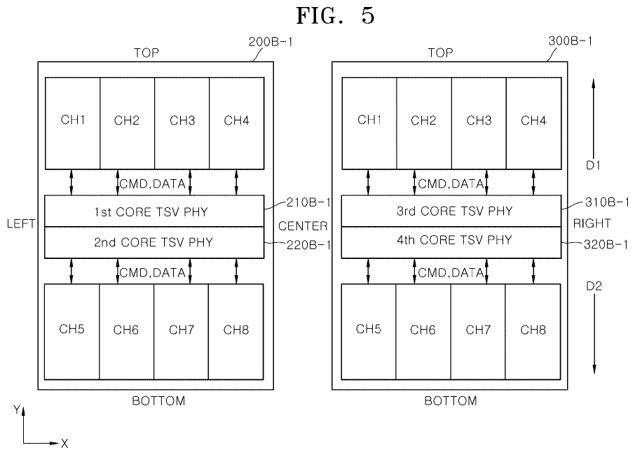

The second area 120B-1 may include a first memory controller (1^{st} MC) 121B-11, a first base interface area (1^{st} DFI) 121B-21, a first base TSV area (1^{st} TSV PHY) 121B-31, a second memory controller (2^{nd} MC) 122B-11, a second base interface area (2^{nd} DFI) 122B-21, and a second base TSV area (2^{nd} TSV PHY) 122B-31 that control an operation of the first memory device 200B-1. The first memory controller 121B-11, the first base interface area 121B-21, and the first base TSV area 121B-31 may be components that control an operation of a first group of channels (CH1 to CH4 in FIG. 5) included in the first memory device 200B-1. The second memory controller 122B-11, the second base interface area 122B-21, and the second base TSV area 122B-31 may be components that control an operation of a second group of channels (CH5 to CH8 in FIG. 5) included in the first memory device 200B-1.

The first memory controller 121B-11, the first base interface area 121B-21, and the first base TSV area 121B-31 may be arranged in the horizontal direction (i.e., X direction) of the control device 100B-1. The second memory controller 122B-11, the second base interface area 122B-21, and the second base TSV area 122B-31 may be arranged in the horizontal direction (i.e., X direction) of the control device 100B-1.

The first memory controller 121B-11 may be electrically connected to the first internal input and output line MIO1. The first memory controller 121B-11 may receive the command CMD and the data DATA that control an operation of the first group of channels (CH1 to CH4 in FIG. 5) included in the first memory device 200B-1 through the first internal input and output line MIO1. The first memory controller 121B-11 may output the command CMD and the data DATA that control an operation of the first group of channels (CH1 to CH4 in FIG. 5) included in the first memory device 200B-1.

The first base interface area 121B-21 may be electrically connected to the first memory controller 121B-11. The first base interface area 121B-21 may receive the command CMD and the data DATA from the first memory controller 121B-11. The first base interface area 121B-21 may output the command CMD and the data DATA to the first base TSV area 121B-31 by adjusting the input and output sequence of the command CMD and the data DATA.

The first base TSV area 121B-31 may be electrically connected to the first base interface area 121B-21. The first base TSV area 121B-31 may receive the command CMD and the data DATA from the first base interface area 121B-21. The first base TSV area 121B-31 may output the command CMD and the data DATA to a first core TSV area (1^{st} CORE TSV PHY) (210B-1 in FIG. 5) included in the first memory device 200B-1 through a plurality of TSVs.

The first memory controller 121B-11, the first base interface area 121B-21, and the first base TSV area 121B-31 may be sequentially disposed in a second direction D2 from the first edge area TOP of the control device 100B-1. The second direction D2 may be set as a direction from the first edge area TOP to a central area CENTER. The first edge area TOP may be set as an upper area of the control device 100B-1 in a Y axis. The first edge area TOP may be placed in an outward direction from the central area CENTER.

The second memory controller 122B-11 may be electrically connected to the second internal input and output line MIO2. The second memory controller 122B-11 may receive the command CMD and the data DATA that control an operation of the second group of channels (CH5 to CH8 in FIG. 5) included in the first memory device 200B-1 through the second internal input and output line MIO2. The second memory controller 122B-11 may output the command CMD and the data DATA that control an operation of the second group of channels (CH5 to CH8 in FIG. 5) included in the first memory device 200B-1.

The second base interface area 122B-21 may be electrically connected to the second memory controller 122B-11. The second base interface area 122B-21 may receive the command CMD and the data DATA from the second memory controller 122B-11. The second base interface area 122B-21 may output the command CMD and the data DATA to the second base TSV area 122B-31 by adjusting the input and output sequence of the command CMD and the data DATA.

The second base TSV area 122B-31 may be electrically connected to the second base interface area 122B-21. The second base TSV area 122B-31 may receive the command CMD and the data DATA from the second base interface area 122B-21. The second base TSV area 122B-31 may output the command CMD and the data DATA to a second core TSV area (2^{nd} CORE TSV PHY) (220B-1 in FIG. 5) included in the first memory device 200B-1 through a plurality of TSVs.

The second memory controller 122B-11, the second base interface area 122B-21, and the second base TSV area 122B-31 may be sequentially disposed in a first direction D1 from the second edge area BOTTOM of the control device 100B-1. The first direction D1 may be set as a direction from the second edge area BOTTOM to the central area CENTER. The second edge area BOTTOM may be set as a lower area of the control device 100B-1 in the Y axis. The second edge area BOTTOM may be placed in an outward direction from the central area CENTER. The first edge area TOP and the second edge area BOTTOM may be placed in opposite directions from the central area CENTER.

The second area 120B-1 may include a third memory controller (3^{rd} MC) 123B-11, a third base interface area (3^{rd} DFI) 123B-21, a third base TSV area (3^{rd} TSV PHY) 123B-31, a fourth memory controller (4^{th} MC) 124B-11, a fourth base interface area (4^{th} DFI) 124B-21, and a fourth base TSV area (4^{th} TSV PHY) 124B-31 that control an operation of the second memory device 300B-1. The third memory controller 123B-11, the third base interface area 123B-21, and the third base TSV area 123B-31 may be components that control an operation of a first group of channels (CH1 to CH4 in FIG. 5) included in the second memory device 300B-1. The fourth memory controller 124B-11, the fourth base interface area 124B-21, and the fourth base TSV area 124B-31 may be components that control an operation of a second group of channels (CH5 to CH8 in FIG. 5) included in the second memory device 300B-1.

The third memory controller 123B-11, the third base interface area 123B-21, and the third base TSV area 123B-31 may be arranged in the horizontal direction (i.e., X direction) of the control device 100B-1. The fourth memory controller 124B-11, the fourth base interface area 124B-21, and the fourth base TSV area 124B-31 may be arranged in the horizontal direction (i.e., X direction) of the control device 100B-1.

The third memory controller 123B-11 may be electrically connected to the first internal input and output line MIO1. The third memory controller 123B-11 may receive the command CMD and the data DATA that control an operation of the first group of channels (CH1 to CH4 in FIG. 5) included in the second memory device 300B-1 through the first internal input and output line MIO1. The third memory controller 123B-11 may output the command CMD and the data DATA that control an operation of the first group of channels (CH1 to CH4 in FIG. 5) included in the second memory device 300B-1.

The third base interface area 123B-21 may be electrically connected to the third memory controller 123B-11. The third base interface area 123B-21 may receive the command CMD and the data DATA from the third memory controller 123B-11. The third base interface area 123B-21 may output the command CMD and the data DATA to the third base TSV area 123B-31 by adjusting the input and output sequence of the command CMD and the data DATA.

The third base TSV area 123B-31 may be electrically connected to the third base interface area 123B-21. The third base TSV area 123B-31 may receive the command CMD and the data DATA from the third base interface area 123B-21. The third base TSV area 123B-31 may output the command CMD and the data DATA to a third core TSV area (3^{rd} CORE TSV PHY) (310B-1 in FIG. 5) included in the second memory device 300B-1 through a plurality of TSVs.

The third memory controller 123B-11, the third base interface area 123B-21, and the third base TSV area 123B-31 may be sequentially disposed in the second direction D2 from the first edge area TOP of the control device 100A.

The fourth memory controller 124B-11 may be electrically connected to the second internal input and output line MIO2. The fourth memory controller 124B-11 may receive the command CMD and the data DATA that control an operation of the second group of channels (CH5 to CH8 in FIG. 5) included in the second memory device 300B-1 and through the second internal input and output line MIO2. The fourth memory controller 124B-11 may output the command CMD and the data DATA that control an operation of the second group of channels (CH5 to CH8 in FIG. 5) included in the second memory device 300B-1.

The fourth base interface area 124B-21 may be electrically connected to the fourth memory controller 124B-11. The fourth base interface area 124B-21 may receive the command CMD and the data DATA from the fourth memory controller 124B-11. The fourth base interface area 124B-21 may output the command CMD and the data DATA to the fourth base TSV area 124B-31 by adjusting the input and output sequence of the command CMD and the data DATA.

The fourth base TSV area 124B-31 may be electrically connected to the fourth base interface area 124B-21. The fourth base TSV area 124B-31 may receive the command CMD and the data DATA from the fourth base interface area 124B-21. The fourth base TSV area 124B-31 may output the command CMD and the data DATA to a fourth core TSV area (4^{th} CORE TSV PHY) (320B-1 in FIG. 5) included in the second memory device 300B-1 through a plurality of TSVs.

The fourth memory controller 124B-11, the fourth base interface area 124B-21, and the fourth base TSV area 124B-31 may be sequentially disposed in the first direction D1 from the second edge area BOTTOM of the control device 100B-1.

The second area 120B-1 may be set as an area in which the command CMD and the data DATA are received from the first area 110B-1 and output to the first memory device 200B-1 and the second memory device 300B-1. The second area 120B-1 may be disposed in a right area RIGHT in the X axis of the control device 100B-1.

FIG. 5 is a block diagram illustrating a construction of the first memory device 200B-1 and the second memory device 300B-1 according to an embodiment of the present disclosure.

The first memory device 200B-1 may include the first to eighth channels CH1 to CH8, the first core TSV area 210B-1, and the second core TSV area 220B-1.

The first core TSV area 210B-1 and the second core TSV area 220B-1 may be arranged in the horizontal direction (i.e., X direction) of the first memory device 200B-1.

The first to eighth channels CH1 to CH8 may receive the command CMD and the data DATA by independently performing internal operations. The first to eighth channels CH1 to CH8 may each store the data DATA based on the command CMD after the start of a write operation of an internal operation. The first to eighth channels CH1 to CH8 may each output the data DATA based on the command CMD after the start of a read operation of an internal operation.

The first to fourth channels CH1 to CH4 may be electrically connected to the first core TSV area 210B-1. The first to fourth channels CH1 to CH4 may receive the command CMD and the data DATA from the first core TSV area 210B-1. The first to fourth channels CH1 to CH4 may output the data DATA to the first core TSV area 210B-1. The first to fourth channels CH1 to CH4 may each store the data DATA based on the command CMD after the start of a write operation of an internal operation. The first to fourth channels CH1 to CH4 may each output the data DATA based on the command CMD after the start of a read operation of an internal operation. The first to fourth channels CH1 to CH4 may be set as the first group of channels.

The fifth to eighth channels CH5 to CH8 may be electrically connected to the second core TSV area 220B-1. The fifth to eighth channels CH5 to CH8 may receive a command CMD and data DATA from the second core TSV area 220B-1. The fifth to eighth channels CH5 to CH8 may output the data DATA to the second core TSV area 220B-1. The fifth to eighth channels CH5 to CH8 may each store the data DATA based on the command CMD after the start of a write operation of an internal operation. The fifth to eighth channels CH5 to CH8 may each output the data DATA based on the command CMD after the start of a read operation of an internal operation. The fifth to eighth channels CH5 to CH8 may be set as the second group of channels.

The first to fourth channels CH1 to CH4 may be disposed in the first edge area TOP of the first memory device 200B-1. The fifth to eighth channels CH5 to CH8 may be disposed in the second edge area BOTTOM of the first memory device 200B-1.

The first core TSV area 210B-1 may be electrically connected to the first base TSV area 121B-31 of the control device 100B-1. The first core TSV area 210B-1 may receive the command CMD and the data DATA from the first base TSV area 121B-31. The first core TSV area 210B-1 may receive the command CMD and the data DATA through the plurality of TSVs. The first core TSV area 210B-1 may output the command CMD and the data DATA to the first to fourth channels CH1 to CH4. The first core TSV area 210B-1 may receive the data DATA from the first to fourth channels CH1 to CH4 and output the data DATA to the first base TSV area 121B-31. The first core TSV area 210B-1 may be disposed in the central area CENTER. The first core TSV area 210B-1 may be disposed in the second direction D2 from the first edge area TOP. The second direction D2 may be set as a direction from the first edge area TOP to the central area CENTER. The first edge area TOP may be set as an upper area of the first memory device 200B-1 in the Y axis. The first edge area TOP may be placed in an outward direction from the central area CENTER.

The second core TSV area 220B-1 may be electrically connected to the second base TSV area 122B-31 of the control device 100B-1. The second core TSV area 220B-1 may receive the command CMD and the data DATA from the second base TSV area 122B-31. The second core TSV area 220B-1 may receive the command CMD and the data DATA through the plurality of TSVs. The second core TSV area 220B-1 may output the command CMD and the data DATA to the fifth to eighth channels CH5 to CH8. The second core TSV area 220B-1 may receive the data DATA from the fifth to eighth channels CH5 to CH8 and output the data DATA to the second base TSV area 122B-31. The second core TSV area 220B-1 may be disposed in the central area CENTER. The second core TSV area 220B-1 may be disposed in the first direction D1 from the second edge area BOTTOM. The first direction D1 may be set as a direction from the second edge area BOTTOM to the central area CENTER. The second edge area BOTTOM may be set as a lower area of the first memory device 200B-1 in the Y axis. The second edge area BOTTOM may be placed in an outward direction from the central area CENTER. The first edge area TOP and the second edge area BOTTOM may be placed in opposite directions from the central area CENTER.

The first memory device 200B-1 may be disposed in the left area LEFT of the X axis.

The second memory device 300B-1 may include the first to eighth channels CH1 to CH8, the third core TSV area 310B-1, and the fourth core TSV area 320B-1.

The third core TSV area 310B-1 and the fourth core TSV area 320B-1 may be arranged in the horizontal direction (i.e., X direction) of the second memory device 300B-1.

The first to eighth channels CH1 to CH8 may receive the command CMD and the data DATA by independently performing internal operations. The first to eighth channels CH1 to CH8 may each store the data DATA based on the command CMD after the start of a write operation of an internal operation. The first to eighth channels CH1 to CH8 may each output the data DATA based on the command CMD after the start of a read operation of an internal operation.

The first to fourth channels CH1 to CH4 may be electrically connected to the third core TSV area 310B-1. The first to fourth channels CH1 to CH4 may receive the command CMD and the data DATA from the third core TSV area 310B-1. The first to fourth channels CH1 to CH4 may output the data DATA to the third core TSV area 310B-1. The first to fourth channels CH1 to CH4 may each store the data DATA based on the command CMD after the start of a write operation of an internal operation. The first to fourth channels CH1 to CH4 may each output the data DATA based on the command CMD after the start of a read operation of an internal operation. The first to fourth channels CH1 to CH4 may be set as the first group of channels.

The fifth to eighth channels CH5 to CH8 may be electrically connected to the fourth core TSV area 320B-1. The fifth to eighth channels CH5 to CH8 may receive a command CMD and data DATA from the fourth core TSV area 320B-1. The fifth to eighth channels CH5 to CH8 may output the data DATA to the fourth core TSV area 320B-1. The fifth to eighth channels CH5 to CH8 may each store the data DATA based on the command CMD after the start of a write operation of an internal operation. The fifth to eighth channels CH5 to CH8 may each output the data DATA based on the command CMD after the start of a read operation of an internal operation. The fifth to eighth channels CH5 to CH8 may be set as the second group of channels.

The first to eighth channels CH1 to CH8 may be disposed in the first edge area TOP of the second memory device 300B-1.

The third core TSV area 310B-1 may be electrically connected to the third base TSV area 123B-31 of the control device 100B-1. The third core TSV area 310B-1 may receive the command CMD and the data DATA from the third base TSV area 123B-31. The third core TSV area 310B-1 may receive the command CMD and the data DATA through the plurality of TSVs. The third core TSV area 310B-1 may output the command CMD and the data DATA to the first to fourth channels CH1 to CH4. The third core TSV area 310B-1 may receive the data DATA from the first to fourth channels CH1 to CH4 and output the data DATA to the third base TSV area 123B-31. The third core TSV area 310B-1 may be disposed in the central area CENTER. The third core TSV area 310B-1 may be disposed in the second direction D2 from the first edge area TOP.

The fourth core TSV area 320B-1 may be electrically connected to the fourth base TSV area 124B-31 of the control device 100B-1. The fourth core TSV area 320B-1 may receive the command CMD and the data DATA from the fourth base TSV area 124B-31. The fourth core TSV area 320B-1 may receive the command CMD and the data DATA through the plurality of TSVs. The fourth core TSV area 320B-1 may output the command CMD and the data DATA to the fifth to eighth channels CH5 to CH8. The fourth core TSV area 320B-1 may receive the data DATA from the fifth to eighth channels CH5 to CH8 and output the data DATA to the fourth base TSV area 124B-31. The fourth core TSV area 320B-1 may be disposed in the central area CENTER. The fourth core TSV area 320B-1 may be disposed in the first direction D1 from the second edge area BOTTOM.

The second memory device 300B-1 may be disposed in the right area RIGHT of the X axis.

As described above, the semiconductor system 1B according to an embodiment of the present disclosure can increase the bandwidth because the first memory device 200B-1 and the second memory device 300B-1 are connected to the control device 100B-1 in common and input and output the data DATA. The semiconductor system 1B can prevent or reduce heat from an area in which the command CMD and the data DATA are generated from being diffused to a memory device because the memory device (e.g., 200B-1 and 300B-1) are not stacked above the area in which the command CMD and the data DATA are generated.

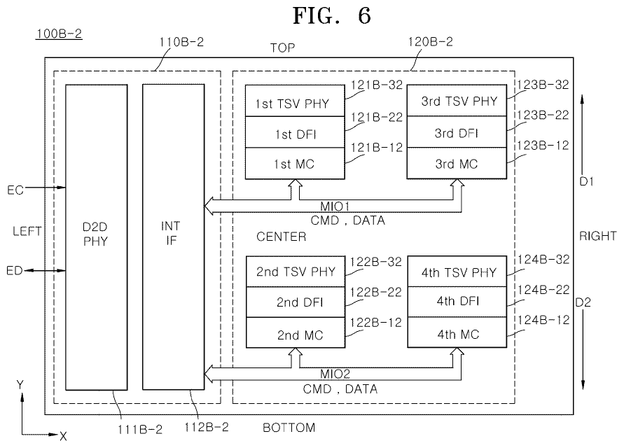

FIG. 6 is a block diagram illustrating a construction of the control device 100 according to an embodiment of the present disclosure. As illustrated in FIG. 6, a control device 100B-2 may include a first area 110B-2 and a second area 120B-2.

The first area 110B-2 may include a physical area (D2D PHY) 111B-2 and an internal interface area (INT IF) 112B-2.

The physical area 111B-2 may generate the command CMD based on an external command EC from an external device (e.g., the processor in FIG. 8). The physical area 111B-2 may generate the command CMD by buffering or decoding the external command EC. The external command EC and the command CMD each have been illustrated as one signal, but may each include a plurality of bits. The physical area 111B-2 may generate the data DATA by receiving external data ED from an external device (e.g., the processor in FIG. 8). The physical area 111B-2 may generate the external data ED by receiving the data DATA from the internal interface area 112B-2. The physical area 111B-2 may output the external data ED to an external device (e.g., the processor in FIG. 8). The external data ED and the data DATA each have been illustrated as one signal, but may each include a plurality of bits.

The internal interface area 112B-2 may receive the command CMD and the data DATA from the physical area 111B-2. The internal interface area 112B-2 may output the command CMD and the data DATA to a first internal input and output line MIO1 by adjusting the input and output sequence of the command CMD and the data DATA that control operations of a first memory device 200B-2 and a second memory device 300B-2. The internal interface area 112B-2 may output the command CMD and the data DATA to a second internal input and output line MIO2 by adjusting the input and output sequence of the command CMD and the data DATA that control operations of the first memory device 200B-2 and the second memory device 300B-2. The first internal input and output line MIO1 may be disposed in a central area CENTER of the control device 100B-2. The second internal input and output line MIO2 may be disposed in a second edge area BOTTOM of the control device 100B-2.

The first area 110B-2 may be set as an area in which the command CMD and the data DATA are generated. The first area 110B-2 may be set as an area in which heat is generated when the command CMD and the data DATA are generated. The first area 110B-2 may be disposed in a left area LEFT of the control device 100B-2 in an X axis.

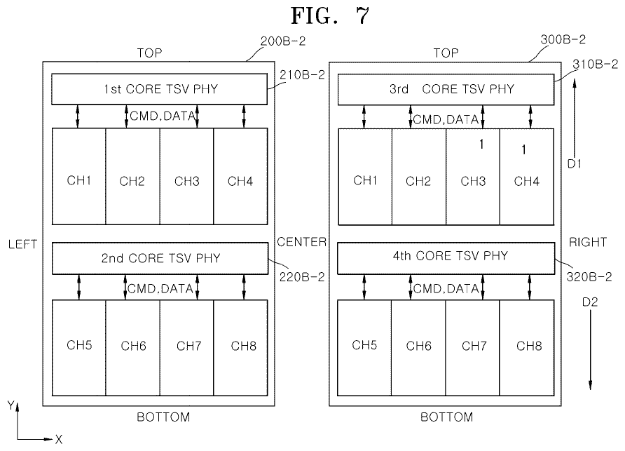

The second area 120B-2 may include a first memory controller (1^{st} MC) 121B-12, a first base interface area (1^{st} DFI) 121B-22, a first base TSV area (1^{st} TSV PHY) 121B-32, a second memory controller (2^{nd} MC) 122B-12, a second base interface area (2^{nd} DFI) 122B-22, and a second base TSV area (2^{nd} TSV PHY) 122B-32 that control an operations of the first memory device 200B-2. The first memory controller 121B-12, the first base interface area 121B-22, and the first base TSV area 121B-32 may be components that control an operation of a first group of channels (CH1 to CH4 in FIG. 7) included in the first memory device 200B-2. The second memory controller 122B-12, the second base interface area 122B-22, and the second base TSV area 122B-32 may be components that control an operation of a second group of channels (CH5 to CH8 in FIG. 7) included in the first memory device 200B-2.

The first memory controller 121B-12, the first base interface area 121B-22, and the first base TSV area 121B-32 may be arranged in the horizontal direction (i.e., X direction) of the control device 100B-2. The second memory controller 122B-12, the second base interface area 122B-22, and a second base TSV area 122B-32 may be arranged in the horizontal direction (i.e., X direction) of the control device 100B-2.

The first memory controller 121B-12 may be electrically connected to the first internal input and output line MIO1. The first memory controller 121B-12 may receive the command CMD and the data DATA that control an operation of the first group of channels (CH1 to CH4 in FIG. 7) included in the first memory device 200B-2 through the first internal input and output line MIO1. The first memory controller 121B-12 may output the command CMD and the data DATA that control an operation of the first group of channels (CH1 to CH4 in FIG. 7) included in the first memory device 200B-2.

The first base interface area 121B-22 may be electrically connected to the first memory controller 121B-12. The first base interface area 121B-22 may receive the command CMD and the data DATA from the first memory controller 121B-12. The first base interface area 121B-22 may output the command CMD and the data DATA to the first base TSV area 121B-32 by adjusting the input and output sequence of the command CMD and the data DATA.

The first base TSV area 121B-32 may be electrically connected to the first base interface area 121B-22. The first base TSV area 121B-32 may receive the command CMD and the data DATA from the first base interface area 121B-22. The first base TSV area 121B-32 may output the command CMD and the data DATA to a first core TSV area (1st CORE TSV PHY) (210B-2 in FIG. 7) included in the first memory device 200B-2 through a plurality of TSVs.

The first memory controller 121B-12, the first base interface area 121B-22, and the first base TSV area 121B-32 may be sequentially disposed in a first direction D1 from the central area CENTER of the control device 100B-2. The first direction D1 may be set as a direction from the central area CENTER to a first edge area TOP. The first edge area TOP may be set as an upper area of the control device 100B-2 in a Y axis. The first edge area TOP may be placed in an outward direction from the central area CENTER.

The second memory controller 122B-12 may be electrically connected to the second internal input and output line MIO2. The second memory controller 122B-12 may receive the command CMD and the data DATA that control an operation of the second group of channels (CH5 to CH8 in FIG. 7) included in the first memory device 200B-2 through the second internal input and output line MIO2. The second memory controller 122B-12 may output the command CMD and the data DATA that control an operation of the second group of channels (CH5 to CH8 in FIG. 7) included in the first memory device 200B-2.

The second base interface area 122B-22 may be electrically connected to the second memory controller 122B-12. The second base interface area 122B-22 may receive the command CMD and the data DATA from the second memory controller 122B-12. The second base interface area 122B-22 may output the command CMD and the data DATA to the second base TSV area 122B-32 by adjusting the input and output sequence of the command CMD and the data DATA.

The second base TSV area 122B-32 may be electrically connected to the second base interface area 122B-22. The second base TSV area 122B-32 may receive the command CMD and the data DATA from the second base interface area 122B-22. The second base TSV area 122B-32 may output the command CMD and the data DATA to a second core TSV area (2nd CORE TSV PHY) (220B-2 in FIG. 7) included in the first memory device 200B-2 through a plurality of TSVs.

The second memory controller 122B-12, the second base interface area 122B-22, and the second base TSV area 122B-32 may be sequentially disposed in the first direction D1 from the second edge area BOTTOM of the control device 100B-2. The first direction D1 may be set as a direction from the second edge area BOTTOM to the central area CENTER. The second edge area BOTTOM may be set as a lower area of the control device 100B-2 in the Y axis. The second edge area BOTTOM may be placed in an outward direction from the central area CENTER. The first edge area TOP and the second edge area BOTTOM may be placed in opposite directions from the central area CENTER.

The second area 120B-2 may include a third memory controller (3^{rd} MC) 123B-12, a third base interface area (3^{rd} DFI) 123B-22, a third base TSV area (3^{rd} TSV PHY) 123B-32, a fourth memory controller (4^{th} MC) 124B-12, a fourth base interface area (4^{th} DFI) 124B-22, and a fourth base TSV area (4^{th} TSV PHY) 124B-32 that control an operation of the second memory device 300B-2. The third memory controller 123B-12, the third base interface area 123B-22 and the third base TSV area 123B-32 may be components that control an operation of a first group of channels (CH1 to CH4 in FIG. 7) included in the second memory device 300B-2. The fourth memory controller 124B-12, the fourth base interface area 124B-22, and the fourth base TSV area 124B-32 may be components that control an operation of a second group of channels (CH5 to CH8 in FIG. 7) included in the second memory device 300B-2.

The third memory controller 123B-12, the third base interface area 123B-22, and the third base TSV area 123B-32 may be arranged in the horizontal direction (i.e., X direction) of the control device 100B-2. The fourth memory controller 124B-12, the fourth base interface area 124B-22, and the fourth base TSV area 124B-32 may be arranged in the horizontal direction (i.e., X direction) of the control device 100B-2.

The third memory controller 123B-12 may be electrically connected to the first internal input and output line MIO1. The third memory controller 123B-12 may receive the command CMD and the data DATA that control an operation of the first group of channels (CH1 to CH4 in FIG. 7) included in the second memory device 300B-2 through the first internal input and output line MIO1. The third memory controller 123B-12 may output the command CMD and the data DATA that control an operation of the first group of channels (CH1 to CH4 in FIG. 7) included in the second memory device 300B-2.

The third base interface area 123B-22 may be electrically connected to the third memory controller 123B-12. The third base interface area 123B-22 may receive the command CMD and the data DATA from the third memory controller 123B-12. The third base interface area 123B-22 may output the command CMD and the data DATA to the third base TSV area 123B-32 by adjusting the input and output sequence of the command CMD and the data DATA.

The third base TSV area 123B-32 may be electrically connected to the third base interface area 123B-22. The third base TSV area 123B-32 may receive the command CMD and the data DATA from the third base interface area 123B-22. The third base TSV area 123B-32 may output the command CMD and the data DATA to a third core TSV area (3^{rd} CORE TSV PHY) (310B-2 in FIG. 7) included in the second memory device 300B-2 through a plurality of TSVs.

The third memory controller 123B-12, the third base interface area 123B-22, and the third base TSV area 123B-32 may be sequentially disposed in the first direction D1 from the central area CENTER of the control device 100B-2.

The fourth memory controller 124B-12 may be electrically connected to the second internal input and output line MIO2. The fourth memory controller 124B-12 may receive the command CMD and the data DATA that control an operation of the second group of channels (CH5 to CH8 in FIG. 7) included in the second memory device 300B-2 through the second internal input and output line MIO2. The fourth memory controller 124B-12 may output the command CMD and the data DATA that control an operation of the second group of channels (CH5 to CH8 in FIG. 7) included in the second memory device 300B-2.

The fourth base interface area 124B-22 may be electrically connected to the fourth memory controller 124B-12. The fourth base interface area 124B-22 may receive the command CMD and the data DATA from the fourth memory controller 124B-12. The fourth base interface area 124B-22 may output the command CMD and the data DATA to the fourth base TSV area 124B-32 by adjusting the input and output sequence of the command CMD and the data DATA.

The fourth base TSV area 124B-32 may be electrically connected to the fourth base interface area 124B-22. The fourth base TSV area 124B-32 may receive the command CMD and the data DATA from the fourth base interface area 124B-22. The fourth base TSV area 124B-32 may output the command CMD and the data DATA to a fourth core TSV area (4^{th} CORE TSV PHY) (320B-2 in FIG. 7) included in the second memory device 300B-2 through a plurality of TSVs.

The fourth memory controller 124B-12, the fourth base interface area 124B-22, and the fourth base TSV area 124B-32 may be sequentially disposed in the first direction D1 from the second edge area BOTTOM of the control device 100B-2.

The second area 120B-2 may be set as an area in which the command CMD and the data DATA are received from the first area 110B-2 and output to the first memory device 200B-2 and the second memory device 300B-2. The second area 120B-2 may be disposed in a right area RIGHT of the control device 100B-2 in the X axis.

FIG. 7 is a block diagram illustrating a construction of the first memory device 200B-2 and the second memory device 300B-2 according to an embodiment of the present disclosure.

The first memory device 200B-2 may include the first to eighth channels CH1 to CH8, the first core TSV area 210B-2, and the second core TSV area 220B-2.

The first core TSV area 210B-2 and the second core TSV area 220B-2 may be arranged in the horizontal direction (i.e., X direction) of the first memory device 200B-2.

The first to eighth channels CH1 to CH8 may receive the command CMD and the data DATA by independently performing internal operations. The first to eighth channels CH1 to CH8 may each store the data DATA based on the command CMD after the start of a write operation of an internal operation. The first to eighth channels CH1 to CH8 may each output the data DATA based on the command CMD after the start of a read operation of an internal operation.

The first to fourth channels CH1 to CH4 may be electrically connected to the first core TSV area 210B-2. The first to fourth channels CH1 to CH4 may receive the command CMD and the data DATA from the first core TSV area 210B-2. The first to fourth channels CH1 to CH4 may output the data DATA to the first core TSV area 210B-2. The first to fourth channels CH1 to CH4 may each store the data DATA based on the command CMD after the start of a write operation of an internal operation. The first to fourth channels CH1 to CH4 may each output the data DATA based on the command CMD after the start of a read operation of an internal operation. The first to fourth channels CH1 to CH4 may be set as the first group of channels.

The fifth to eighth channels CH5 to CH8 may be electrically connected to the second core TSV area 220B-2. The fifth to eighth channels CH5 to CH8 may receive a command CMD and data DATA from the second core TSV area 220B-2. The fifth to eighth channels CH5 to CH8 may output the data DATA to the second core TSV area 220B-2. The fifth to eighth channels CH5 to CH8 may each store the data DATA based on the command CMD after the start of a write operation of an internal operation. The fifth to eighth channels CH5 to CH8 may each output the data DATA based on the command CMD after the start of a read operation of an internal operation. The fifth to eighth channels CH5 to CH8 may be set as the second group of channels.

The first to fourth channels CH1 to CH4 may be disposed in a central area CENTER of the first memory device 200B-2. The fifth to eighth channels CH5 to CH8 may be disposed in a second edge area BOTTOM of the first memory device 200B-2.

The first core TSV area 210B-2 may be electrically connected to the first base TSV area 121B-32 of the control device 100B-2. The first core TSV area 210B-2 may receive the command CMD and the data DATA from the first base TSV area 121B-32. The first core TSV area 210B-2 may receive the command CMD and the data DATA through a plurality of TSVs. The first core TSV area 210B-2 may output the command CMD and the data DATA to the first to fourth channels CH1 to CH4. The first core TSV area 210B-2 may receive the data DATA from the first to fourth channels CH1 to CH4 and output the data DATA to the first base TSV area 121B-32. The first core TSV area 210B-2 may be disposed in a first direction D1 from the central area CENTER. The first direction D1 may be set as a direction from the central area CENTER to a first edge area TOP. The first edge area TOP may be set as an upper area of the first memory device 200B-2 in the Y axis. The first edge area TOP may be placed in an outward direction from the central area CENTER.

The second core TSV area 220B-2 may be electrically connected to the second base TSV area 122B-32 of the control device 100B-2. The second core TSV area 220B-2 may receive the command CMD and the data DATA from the second base TSV area 122B-32. The second core TSV area 220B-2 may receive the command CMD and the data DATA through the plurality of TSVs. The second core TSV area 220B-2 may output the command CMD and the data DATA to the fifth to eighth channels CH5 to CH8. The second core TSV area 220B-2 may receive the data DATA from the fifth to eighth channels CH5 to CH8 and output the data DATA to the second base TSV area 122B-32. The second core TSV area 220B-2 may be disposed in the central area CENTER. The second core TSV area 220B-2 may be disposed in the first direction D1 from the second edge area BOTTOM. The first direction D1 may be set as a direction from the second edge area BOTTOM to the central area CENTER. The second edge area BOTTOM may be set as a lower area of the first memory device 200B-2 in a Y axis. The second edge area BOTTOM may be placed in an outward direction from the central area CENTER. The first edge area TOP and the second edge area BOTTOM may be placed in opposite directions from the central area CENTER.

The first memory device 200B-2 may be disposed of in a left area LEFT of the first memory device 200B-2 in an X axis.

The second memory device 300B-2 may include the first to eighth channels CH1 to CH8, the third core TSV area 310B-2, and the fourth core TSV area 320B-2.

The third core TSV area 310B-2 and the fourth core TSV area 320B-2 may be arranged in the horizontal direction (i.e., X direction) of the second memory device 300B-2.

The first to eighth channels CH1 to CH8 may receive the command CMD and the data DATA by independently performing internal operations. The first to eighth channels CH1 to CH8 may each store the data DATA based on the command CMD after the start of a write operation of an internal operation. The first to eighth channels CH1 to CH8 may each output the data DATA based on the command CMD after the start of a read operation of an internal operation.

The first to fourth channels CH1 to CH4 may be electrically connected to the third core TSV area 310B-2. The first to fourth channels CH1 to CH4 may receive the command CMD and the data DATA from the third core TSV area 310B-2. The first to fourth channels CH1 to CH4 may output the data DATA to the third core TSV area 310B-2. The first to fourth channels CH1 to CH4 may each store the data DATA based on the command CMD after the start of a write operation of an internal operation. The first to fourth channels CH1 to CH4 may each output the data DATA based on the command CMD after the start of a read operation of an internal operation. The first to fourth channels CH1 to CH4 may be set as the first group of channels.

The fifth to eighth channels CH5 to CH8 may be electrically connected to the fourth core TSV area 320B-2. The fifth to eighth channels CH5 to CH8 may receive a command CMD and data DATA from the fourth core TSV area 320B-2. The fifth to eighth channels CH5 to CH8 may output the data DATA to the fourth core TSV area 320B-2. The fifth to eighth channels CH5 to CH8 may each store the data DATA based on the command CMD after the start of a write operation of an internal operation. The fifth to eighth channels CH5 to CH8 may each output the data DATA based on the command CMD after the start of a read operation of an internal operation. The fifth to eighth channels CH5 to CH8 may be set as the second group of channels.

The first to fourth channels CH1 to CH4 may be disposed in the central area CENTER of the second memory device 300B-2. The fifth to eighth channels CH5 to CH8 may be disposed in the second edge area BOTTOM of the second memory device 300B-2.

The third core TSV area 310B-2 may be electrically connected to the third base TSV area 123B-32 of the control device 100B-2. The third core TSV area 310B-2 may receive the command CMD and the data DATA from the third base TSV area 123B-32. The third core TSV area 310B-2 may receive the command CMD and the data DATA through a plurality of TSVs. The third core TSV area 310B-2 may output the command CMD and the data DATA to the first to fourth channels CH1 to CH4. The third core TSV area 310B-2 may receive the data DATA from the first to fourth channels CH1 to CH4 and output the data DATA to the third base TSV area 123B-32. The third core TSV area 310B-2 may be disposed in the first edge area TOP. The third core TSV area 310B-2 may be disposed in the first direction D1 from the central area CENTER.

The fourth core TSV area 320B-2 may be electrically connected to the fourth base TSV area 124B-31 of the control device 100B-2. The fourth core TSV area 320B-2 may receive the command CMD and the data DATA from the fourth base TSV area 124B-32. The fourth core TSV area 320B-2 may receive the command CMD and the data DATA through a plurality of TSVs. The fourth core TSV area 320B-2 may output the command CMD and the data DATA to the fifth to eighth channels CH5 to CH8. The fourth core TSV area 320B-2 may receive the data DATA from the fifth to eighth channels CH5 to CH8 and output the data DATA to the fourth base TSV area 124B-32. The fourth core TSV area 320B-2 may be disposed in the central area CENTER. The fourth core TSV area 320B-2 may be disposed in the first direction D1 from the second edge area BOTTOM.

The second memory device 300B-2 may be disposed in the right area RIGHT in the X axis.

As described above, the semiconductor system 1B according to an embodiment of the present disclosure can increase the bandwidth because the first memory device 200B-2 and the second memory device 300B-2 are connected to the control device 100B-2 in common and input and output the data DATA. The semiconductor system 1B can prevent or reduce heat from an area in which the command CMD and the data DATA are generated from being diffused to a memory device because the memory device (i.e., 200B-2 and 300B-2) are not stacked above the area in which the command CMD and the data DATA are generated. Interfaces that are connected to the TSVs of the control device 100B, 100B-1, 100B-2 and the memory devices 200B, 200B-1, 200B-2, 300B, 300B-1, 300B-2 may be variously disposed in the semiconductor system 1B.

FIG. 8 is a block diagram illustrating a construction of a semiconductor device 3B according to an embodiment of the present disclosure. As illustrated in FIG. 8, the semiconductor device 3B may include a PCB 11, a substrate 13, an interposer 15, an HBM device 17, and the processor 19.

The PCB 11 connects several electronic components in order to form an electronic circuit (not illustrated). A copper layer, a solder mask and a silk screen may be formed on the PCB 11. A circuit path that transmits a signal or power may be formed in the copper layer. The solder mask prevents or mitigates damage to the circuit and protects a specific region in which components may be soldered. Furthermore, the silk screen indicates a position or information of an electronic component in the form of characters or symbols printed on a surface of the PCB 11.

The substrate 13 is formed over the PCB 11 through bump pads (e.g., 115), and may mechanically support the interposer 15, the HBM device 17, and the processor 19. The substrate 13 may be used as an insulator as a material, that is, a physical base for the PCB 11, in general. The material of the substrate 13 includes FR4, that is, an insulator made of glass fiber and epoxy resin, ceramics that can withstand a high temperature and can be used in a high frequency circuit or a high temperature environment due to its thermal conductivity, and polyimide that is used as a base material for a flexible PCB due to its flexible characteristic.

The interposer 15 is formed over the substrate 13 through bump pads, and may include wires that connect electronic components (e.g., the HBM device 17 and the processor 19) with unmatched foam factors or pin arrangements. The interposer 15 may convert signals in different interfaces.

The HBM device 17 may be formed over the interposer 15 through micro bump pads (e.g., 117). The HBM device 17 may store data applied by the processor 19 or output data stored in the HBM device 17 to the processor 19, under the control of the processor 19. The HBM device 17 may include a control device 150, a first memory device 160, and a second memory device 170. The first memory device 160 and the second memory device 170 may be stacked on the control device 150 through micro bump pads. The first memory device 160 and the second memory device 170 may each be implemented with a plurality of core chips that is vertically stacked through micro bump pads. The control device 150 and the first memory device 160 and the second memory device 170 may be vertically stacked through TSVs.

The control device 150 may generate the command CMD by receiving the external command EC from the processor 19, and may generate the data DATA by receiving the external data ED from the processor 19. The control device 150 may include the first area (110B, 110B-1, and 110B-2 illustrated in FIGS. 1, 2, 4, and 6) in which the command CMD and the data DATA are generated. The first area may be set as an area in which heat is generated when the command CMD and the data DATA are generated. The control device 150 may output the command CMD and the data DATA to the first memory device 160 and the second memory device 170. The control device 150 may include the second area (120B, 120B-1, and 120B-2 illustrated in FIGS. 1, 2, 4, and 6) in which the command CMD and the data DATA are received from the first area and output to the first memory device 160 and the second memory device 170. The memory device is not stacked on the first area. The first memory device 160 and the second memory device 170 may be disposed on the second area of the control device 150.

The first memory device 160 and the second memory device 170 may each store the data DATA by performing an internal operation and output the data DATA in each memory device based on the command CMD. The first memory device 160 and the second memory device 170 may each include the plurality of channels (CH1 to CH8 in FIGS. 3, 5, and 7) that independently operates. The plurality of channels (CH1 to CH8 in FIGS. 3, 5, and 7) may each store or output the data DATA by independently operating.

The HBM device 17 can increase the bandwidth because the first memory device 160 and the second memory device 170 are connected to the control device 150 in common and input and output the data DATA. The HBM device 17 can prevent or reduce heat from an area in which the command CMD and the data DATA are generated from being diffused to a memory device because the memory device are not stacked above the area in which the command CMD and the data DATA are generated. Interfaces that are connected to the TSVs of the control device 150, the first memory device 160, and the second memory device 170 may be variously disposed of in the HBM device 17.

The processor 19 may transmit the command CMD and the data DATA to the control device 150 through a wire formed within the interposer 15, and may receive the data DATA from the control device 150. The processor 19 may transmit various commands and signals that control internal operations of the control device 150, the first memory device 160, and the second memory device 170, and may receive the results of the internal operations.

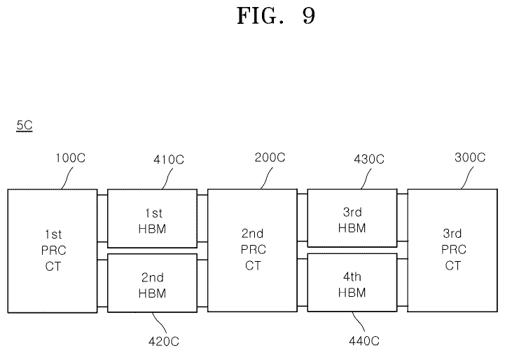

FIG. 9 is a block diagram illustrating a construction of a semiconductor system 5C according to an embodiment of the present disclosure. As illustrated in FIG. 9, the semiconductor system 5C may include a first process circuit (1^{st} PRC CT) 100C, a second process circuit (2^{nd} PRC CT) 200C, a third process circuit (3^{rd} PRC CT) 300C, a first HBM device (1^{st} HMB) 410C, a second HBM device (2^{nd} HMB) 420C, a third HBM device (3^{rd} HMB) 430C, and a fourth HBM device (4^{th} HMB) 440C.

The first process circuit 100C may be electrically connected to the first HBM device 410C and the second HBM device 420C. The first process circuit 100C may be electrically connected to the first HBM device 410C and the second HBM device 420C through the interposer 15 illustrated in FIG. 8. The first process circuit 100C may control operations of the first HBM device 410C and the second HBM device 420C. The first process circuit 100C may perform an arithmetic operation by receiving data DATA from the first HBM device 410C and the second HBM device 420C.

The second process circuit 200C may be electrically connected to the first HBM device 410C and the second HBM device 420C. The second process circuit 200C may be electrically connected to the first HBM device 410C and the second HBM device 420C through the interposer 15 illustrated in FIG. 8. The second process circuit 200C may control operations of the first HBM device 410C and the second HBM device 420C. The second process circuit 200C may perform an arithmetic operation by receiving the data DATA from the first HBM device 410C and the second HBM device 420C. The second process circuit 200C may be electrically connected to the third HBM device 430C and the fourth HBM device 440C. The second process circuit 200C may be electrically connected to the third HBM device 430C and the fourth HBM device 440C through the interposer 15 illustrated in FIG. 8. The second process circuit 200C may control operations of the third HBM device 430C and the fourth HBM device 440C. The second process circuit 200C may perform an arithmetic operation by receiving the data DATA from the third HBM device 430C and the fourth HBM device 440C. The second process circuit 200C may perform an arithmetic operation by receiving the data DATA from at least any one of the first HBM device 410C, the second HBM device 420C, the third HBM device 430C, and the fourth HBM device 440C.

The third process circuit 300C may be electrically connected to the third HBM device 430C and the fourth HBM device 440C. The third process circuit 300C may be electrically connected to the third HBM device 430C and the fourth HBM device 440C through the interposer 15 illustrated in FIG. 8. The third process circuit 300C may control operations of the third HBM device 430C and the fourth HBM device 440C. The third process circuit 300C may perform an arithmetic operation by receiving the data DATA from the third HBM device 430C and the fourth HBM device 440C.

The first process circuit 100C, the second process circuit 200C, and the third process circuit 300C may each be implemented with a graphic processing unit (GPU) device and a neural processing unit (NPU) device.

The arithmetic operation may include a training operation and an inference operation. The training operation may be set as an operation of an artificial intelligence (AI) model learning a rule, a pattern, or a relation by optimizing weights and parameters from given data DATA. The inference operation may be set as an operation of the AI model rapidly deriving results from new data by using weights learned in the training operation.

The first HBM device 410C, the second HBM device 420C, the third HBM device 430C, and the fourth HBM device 440C may each include the control device 100B, the first memory device 200B, and the second memory device 300B illustrated in FIGS. 1 to 8. The first HBM device 410C, the second HBM device 420C, the third HBM device 430C, and the fourth HBM device 440C may each store data DATA and output the data DATA stored in each HBM device.

The first HBM device 410C, the second HBM device 420C, the third HBM device 430C, and the fourth HBM device 440C may each be disposed at the boundary of the physical area (D2D PHY) 111B, 111B-1, 111B-2 illustrated in FIGS. 1, 2, 4, and 6. The first HBM device 410C, the second HBM device 420C, the third HBM device 430C, and the fourth HBM device 440C may each be electrically connected to the first process circuit 100C, the second process circuit 200C, and the third process circuit 300C through the physical area D2D PHY. The first HBM device 410C, the second HBM device 420C, the third HBM device 430C, and the fourth HBM device 440C may be shared by the first process circuit 100C, the second process circuit 200C, and the third process circuit 300C through the physical area D2D PHY.

The semiconductor system 5C according to an embodiment of the present disclosure has a plurality of HBM devices electrically connected to a plurality of process circuits, and can thus extend the capacity of data that is used in an arithmetic operation of the process circuit. The semiconductor system 5C has a plurality of HBM devices shared by a plurality of process circuits, and can thus extend the number of process circuits used in an arithmetic operation. The semiconductor system 5C can rapidly perform an arithmetic operation because a plurality of HBM devices is electrically connected to a plurality of process circuits to perform the arithmetic operation.

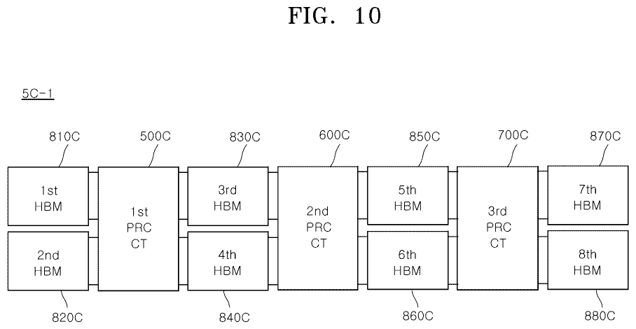

FIG. 10 is a block diagram illustrating a construction of a semiconductor system 5C-1 according to an embodiment of the present disclosure. As illustrated in FIG. 10, the semiconductor system 5C-1 may include a first process circuit (1^{st} PRC CT) 500C, a second process circuit (2^{nd} PRC CT) 600C, a third process circuit (3^{rd} PRC CT) 700C, a first HBM device (1^{st} HMB) 810C, a second HBM device (2^{nd} HMB) 820C, a third HBM device (3^{rd} HMB) 830C, a fourth HBM device (4^{th} HMB) 840C, a fifth HBM device (5^{th} HMB) 850C, a sixth HBM device (6^{th} HMB) 860C, a seventh HBM device (7^{th} HMB) 870C, and an eighth HBM device (8^{th} HMB) 880C.

The first process circuit 500C may be electrically connected to the first HBM device 810C and the second HBM device 820C. The first process circuit 500C may be electrically connected to the first HBM device 810C and the second HBM device 820C through the interposer 15 illustrated in FIG. 8. The first process circuit 500C may control operations of the first HBM device 810C and the second HBM device 820C. The first process circuit 500C may perform an arithmetic operation by receiving data DATA from the first HBM device 810C and the second HBM device 820C. The first process circuit 500C may be electrically connected to the third HBM device 830C and the fourth HBM device 840C. The first process circuit 500C may be electrically connected to the third HBM device 830C and the fourth HBM device 840C through the interposer 15 illustrated in FIG. 8. The first process circuit 500C may control operations of the third HBM device 830C and the fourth HBM device 840C. The first process circuit 500C may perform an arithmetic operation by receiving data DATA from the third HBM device 830C and the fourth HBM device 840C. The first process circuit 500C may perform an arithmetic operation by receiving the data DATA from at least any one of the first HBM device 810C, the second HBM device 820C, the third HBM device 830C, and the fourth HBM device 840C.

The second process circuit 600C may be electrically connected to the third HBM device 830C and the fourth HBM device 840C. The second process circuit 600C may be electrically connected to the third HBM device 830C and the fourth HBM device 840C through the interposer 15 illustrated in FIG. 8. The second process circuit 600C may control operations of the third HBM device 830C and the fourth HBM device 840C. The second process circuit 600C may perform an arithmetic operation by receiving the data DATA from the third HBM device 830C and the fourth HBM device 840C. The second process circuit 600C may be electrically connected to the fifth HBM device 850C and the sixth HBM device 860C. The second process circuit 600C may be electrically connected to the fifth HBM device 850C and the sixth HBM device 860C through the interposer 15 illustrated in FIG. 8. The second process circuit 600C may control operations of the fifth HBM device 850C and the sixth HBM device 860C. The second process circuit 600C may perform an arithmetic operation by receiving data DATA from the fifth HBM device 850C and the sixth HBM device 860C. The second process circuit 600C may perform an arithmetic operation by receiving the data DATA from at least any one of the third HBM device 830C, the fourth HBM device 840C, the fifth HBM device 850C, and the sixth HBM device 860C.

The third process circuit 700C may be electrically connected to the fifth HBM device 850C and the sixth HBM device 860C. The third process circuit 700C may be electrically connected to the fifth HBM device 850C and the sixth HBM device 860C through the interposer 15 illustrated in FIG. 8. The third process circuit 700C may control operations of the fifth HBM device 850C and the sixth HBM device 860C. The third process circuit 700C may perform an arithmetic operation by receiving the data DATA from the fifth HBM device 850C and the sixth HBM device 860C. The third process circuit 700C may be electrically connected to the seventh HBM device 870C and the eighth HBM device 880C. The third process circuit 700C may be electrically connected to the seventh HBM device 870C and the eighth HBM device 880C through the interposer 15 illustrated in FIG. 8. The third process circuit 700C may control operations of the seventh HBM device 870C and the eighth HBM device 880C. The third process circuit 700C may perform an arithmetic operation by receiving data DATA from the seventh HBM device 870C and the eighth HBM device 880C. The third process circuit 700C may perform an arithmetic operation by receiving the data DATA from at least any one of the fifth HBM device 850C, the sixth HBM device 860C, the seventh HBM device 870C and the eighth HBM device 880C.

The first process circuit 500C, the second process circuit 600C, and the third process circuit 700C may each be implemented with a graphic processing unit (GPU) device and a neural processing unit (NPU) device.

The first HBM device 810C, the second HBM device 820C, the third HBM device 830C, the fourth HBM device 840C, the fifth HBM device 850C, the sixth HBM device 860C, the seventh HBM device 870C, and the eighth HBM device 880C may each include the control device 100B, the first memory device 200B, and the second memory device 300B illustrated in FIGS. 1 to 8. The first HBM device 810C, the second HBM device 820C, the third HBM device 830C, the fourth HBM device 840C, the fifth HBM device 850C, the sixth HBM device 860C, the seventh HBM device 870C, and the eighth HBM device 880C may each store data DATA and output the data DATA stored in each HBM device.

The first HBM device 810C, the second HBM device 820C, the third HBM device 830C, the fourth HBM device 840C, the fifth HBM device 850C, the sixth HBM device 860C, the seventh HBM device 870C, and the eighth HBM device 880C may each be disposed at the boundary of the physical area (D2D PHY) 111B, 111B-1, 111B-2 illustrated in FIGS. 1, 2, 4, and 6. The first HBM device 810C, the second HBM device 820C, the third HBM device 830C, the fourth HBM device 840C, the fifth HBM device 850C, the sixth HBM device 860C, the seventh HBM device 870C, and the eighth HBM device 880C may each be electrically connected to the first process circuit 500C, the second process circuit 600C, and the third process circuit 700C through the physical area D2D PHY. The first HBM device 810C, the second HBM device 820C, the third HBM device 830C, the fourth HBM device 840C, the fifth HBM device 850C, the sixth HBM device 860C, the seventh HBM device 870C, and the eighth HBM device 880C may be shared by the first process circuit 500C, the second process circuit 600C, and the third process circuit 700C through the physical area D2D PHY.

The semiconductor system 5C-1 according to an embodiment of the present disclosure has a plurality of HBM devices electrically connected to a plurality of process circuits, and can thus extend the capacity of data that is used in an arithmetic operation of the process circuit. The semiconductor system 5C-1 has a plurality of HBM devices shared by a plurality of process circuits, and can thus extend the number of process circuits used in an arithmetic operation. The semiconductor system 5C-1 can rapidly perform an arithmetic operation because a plurality of HBM devices is electrically connected to a plurality of process circuits to perform the arithmetic operation.

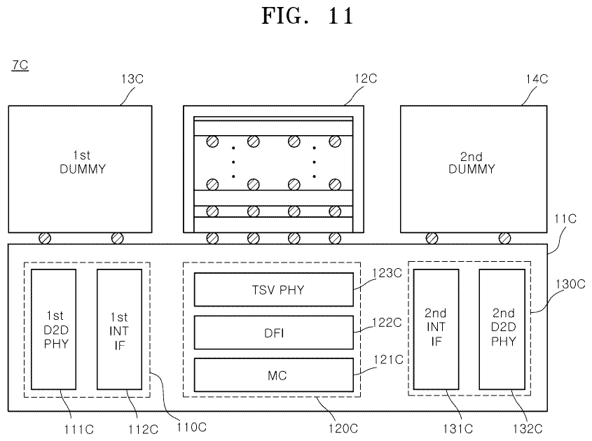

FIG. 11 is a block diagram illustrating a construction of an HBM device 7C according to an embodiment of the present disclosure. As illustrated in FIG. 11, the HBM device 7C may include a control device 11C, a memory device 12C, a first dummy die group (1^{st} DUMMY) 13C, and a second dummy die group (2^{nd} DUMMY) 14C.

The control device 11C may generate a command CMD and data DATA. The control device 11C may output the command CMD and the data DATA to the memory device 12C. The control device 11C may receive data DATA from the memory device 12C. The control device 11C may be a base chip or a controller that controls an operation of the memory device 12C.

The control device 11C may include a first area 110C, a second area 120C, and a third area 130C. An upper part of the first area 110C may be set as a first predetermined area. An upper part of the second area 120C may be set as a second predetermined area. An upper part of the third area 130C may be set as a third predetermined area. The first area 110C may be set as an area that generates a command CMD and data DATA and inputs and outputs the command CMD and the data DATA. Heat may be generated when the first area 110 inputs and outputs the command CMD and the data DATA. The second area 120C may be set as an area that receives the command CMD and the data DATA from the first area 110C and outputs the command CMD and the data DATA to the memory device 12C and that receives the data DATA from the memory device 12C and outputs the data DATA to the first area 110C and the third area 130C. The third area 130C may be set as an area that receives the command CMD and the data DATA and inputs and outputs the command CMD and the data DATA. The third area 130C may be set as an area that inputs and outputs the command CMD and the data DATA to and from another HBM device, the process circuit, or an external device. Heat may be generated when the third area 130C inputs and outputs the command CMD and the data DATA.

The first area 110C may include a first physical area (1^{st} D2D PHY) 111C and a first internal interface area (1^{st} INT IF) 112C.

The first physical area 111C may generate the command CMD and the data DATA based on a signal that is received from the process circuit (PRC CT in FIGS. 9 and 10). The first physical area 111C may output the command CMD and the data DATA to the first internal interface area 112C. The first physical area 111C may receive the data DATA from the first internal interface area 112C and output the data DATA to the process circuit (PRC CT in FIGS. 9 and 10). The first physical area 111C may be a physical layer PHY that is responsible for the generation, transmission, reception, and physical connection of signals and data between the external device and the control device 11C.

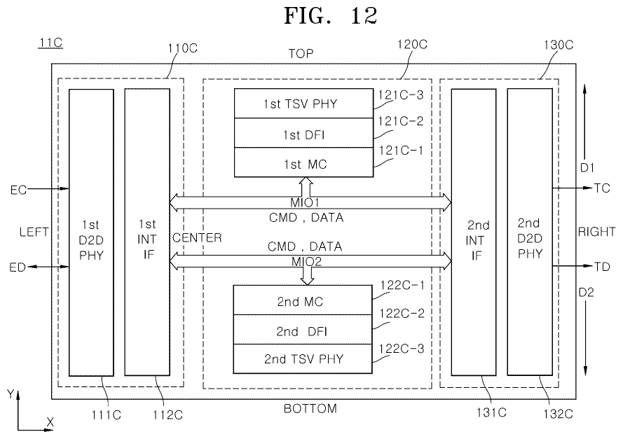

The first internal interface area 112C may receive the command CMD and the data DATA from the first physical area 111C. The first internal interface area 112C may output the command CMD and the data DATA to the internal input and output lines (MIO1 and MIO2 in FIG. 12) by adjusting the input and output sequence of the command CMD and the data DATA. The first internal interface area 112C may receive the data DATA from the internal input and output lines (MIO1 and MIO2 in FIG. 12) and output the data DATA to the first physical area 111C. The first internal interface area 112C may output the command CMD and the data DATA to the second area 120C and the third area 130C by adjusting the input and output sequence of the command CMD and the data DATA. The first internal interface area 112C may be an interface that defines timing and the sequence of signals that are transmitted between the physical layer PHY and internal circuits and that inputs and outputs the signals. The first internal interface area 112C and the internal input and output lines (MIO1 and MIO2 in FIG. 12) may be implemented in a network-on-chip (NoC). The network-on-chip (NoC) may be set as a transmission path that connects several types of internal circuits within a chip.

The second area 120C may include a memory controller (MC) 121C, a base interface area (DFI) 122C, and a base TSV area (TSV PHY) 123C.

The memory controller 121C may receive a command CMD and data DATA through the internal input and output lines (MIO1 and MIO2 in FIG. 12). The memory controller 121C may output the command CMD and the data DATA that control an operation of the memory device 12C to the base interface area 122C. The memory controller 121C may receive the data DATA from the base interface area 122C and output the data DATA to the internal input and output lines (MIO1 and MIO2 in FIG. 12).

The base interface area 122C may receive the command CMD and the data DATA from the memory controller 121C. The base interface area 122C may output the command CMD and the data DATA to the base TSV area 123C by adjusting the input and output sequence of the command CMD and the data DATA. The base interface area 122C may receive the data DATA from the base TSV area 123C and output the data DATA to the memory controller 121C.

The base TSV area 123C may receive the command CMD and the data DATA from the base interface area 122C. The base TSV area 123C may output the command CMD and the data DATA to the memory device 12C through a plurality of TSVs. The base TSV area 123C may receive the data DATA from the memory device 12C and output the data DATA to the base interface area 122C.

The memory controller 121C, the base interface area 122C, and the base TSV area 123C may be disposed in the horizontal direction (i.e., X direction) of the control device 11C.

The third area 130C may include a second internal interface area (2^{nd} INT IF) 131C and a second physical area (2^{nd} D2D PHY) 132C.

The second internal interface area 131C may receive a command CMD and data DATA from the internal input and output lines (MIO1 and MIO2 in FIG. 12). The second internal interface area 131C may output the command CMD and the data DATA to the second physical area 132C by adjusting the input and output sequence of the command CMD and the data DATA. The second internal interface area 131C may be an interface that defines timing and the sequence of signals that are transmitted between the physical layer PHY and internal circuits and that inputs and outputs the signals. The second internal interface area 131C may be implemented in a network-on-chip (NoC).

The second physical area 132C may receive the command CMD and the data DATA from the second internal interface area 131C. The second physical area 132C may output the command CMD and the data DATA to another HBM device and the process circuit (PRC CT in FIGS. 9 and 10). The second physical area 132C may be a physical layer PHY that is responsible for the generation, transmission, reception, and physical connection of signals and data between the external device and the control device 11C.

The memory device 12C may include a plurality of core dies that is vertically stacked. The memory device 12C may be disposed in the second predetermined area. The memory device 12C may receive the command CMD and the data DATA from the base TSV area 123C. The memory device 12C may perform an internal operation based on the command CMD and the data DATA. The memory device 12C may store the data DATA in the plurality of core dies based on the command CMD after the start of a write operation. The memory device 12C may output the data DATA that are stored in the plurality of core dies to the base TSV area 123C based on the command CMD after the start of a read operation.

The first dummy die group 13C may be vertically stacked on the first area 110C of the control device 11C. The first dummy die group 13C may be disposed in the first predetermined area. The first dummy die group 13C may have a plurality of dummy dies (not illustrated) stacked thereon. The first dummy die group 13C may have the same height as the memory device 12C. The first dummy die group 13C may be one dummy die according to an embodiment. The first predetermined area in which the first dummy die group 13C is formed may be an empty space according to an embodiment. The first dummy die group 13C may discharge heat that is generated from the first area 110C of the control device 11C. The plurality of dummy dies (not illustrated) included in the first dummy die group 13C can facilitate the discharge of heat because the plurality of dummy dies is connected through a plurality of TSVs through a plurality of micro bump pads.

The second dummy die group 14C may be vertically stacked on the third area 130C of the control device 11C. The second dummy die group 14C may be disposed in the third predetermined area. The second dummy die group 14C may have a plurality of dummy dies (not illustrated) stacked thereon. The second dummy die group 14C may be one dummy die according to an embodiment. The third predetermined area in which the second dummy die group 14C is formed may be an empty space according to an embodiment. The second dummy die group 14C may discharge heat that is generated from the third area 130C of the control device 11C. The plurality of dummy dies (not illustrated) included in the second dummy die group 14C can facilitate the discharge of heat because the plurality of dummy dies is connected through a plurality of TSVs through the plurality of micro bump pads.

The HBM device 7C according to an embodiment of the present disclosure can prevent a phenomenon in which generated heat is diffused to a memory device because the memory device is not stacked on an area from which the heat is generated due to the input and output of the command CMD and the data DATA. The HBM device 7C according to an embodiment of the present disclosure can facilitate the discharge of heat because a dummy die group is stacked on an area from which the heat is generated due to the input and output of the command CMD and the data DATA.

FIG. 12 is a block diagram illustrating a construction of the control device 11C according to an embodiment of the present disclosure. As illustrated in FIG. 12, the control device 11C may include a first area 110C, a second area 120C, and a third area 130C.

The first area 110C may include a first physical area (1^{st} D2D PHY) 111C and a first internal interface area (1^{st} INT IF) 112C.

The first physical area 111C may generate a command CMD by receiving an external command EC from the process circuit (PRC CT in FIGS. 9 and 10). The first physical area 111C may generate the command CMD by buffering or decoding the external command EC. The external command EC and the command CMD are each illustrated as only one signal, but may each include a plurality of bits. The first physical area 111C may generate data DATA by receiving external data ED from the process circuit (PRC CT in FIGS. 9 and 10). The first physical area 111C may generate the external data ED by receiving data DATA from the first internal interface area 112C. The first physical area 111C may output the external data ED to the process circuit (PRC CT in FIGS. 9 and 10). The external data ED and the data DATA are each illustrated as only one signal, but may each include a plurality of bits.

The first internal interface area 112C may receive the command CMD and the data DATA from the first physical area 111C. The first internal interface area 112C may output the command CMD and the data DATA that control an operation of the memory device 12C to a first internal input and output line MIO1 by adjusting the input and output sequence of the command CMD and the data DATA. The first internal interface area 112C may output the command CMD and the data DATA that control an operation of the memory device 12C to a second internal input and output line MIO2 by adjusting the input and output sequence of the command CMD and the data DATA. The first internal input and output line MIO1 and the second internal input and output line MIO2 may be disposed in a central area CENTER of the control device 11C. The first internal interface area 112C, the first internal input and output line MIO1, and the second internal input and output line MIO2 may be implemented in a network-on-chip (NoC).

The first area 110C may be set as an area that generates a command CMD and data DATA and inputs and outputs the command CMD and the data DATA. Heat may be generated when the first area 110C inputs and outputs the command CMD and the data DATA. The first area 110C may be disposed in a left area LEFT of the control device 11C in an X axis.

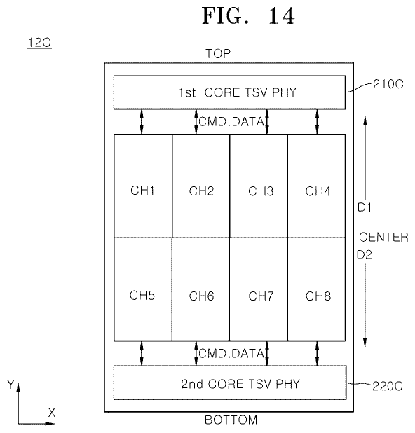

The second area 120C may include a first memory controller (1^{st} MC) 121C-1, a first base interface area (1^{st} DFI) 121C-2, a first base TSV area (1^{st} TSV PHY) 121C-3, a second memory controller (2^{nd} MC) 122C-1, a second base interface area (2^{nd} DFI) 122C-2, and a second base TSV area (2^{nd} TSV PHY) 122C-3 that control an operation of the memory device 12C. The first memory controller 121C-1, the first base interface area 121C-2, and the first base TSV area 121C-3 may be components that control an operation of a first group of channels (CH1 to CH4 in FIG. 14) included in a memory device 12C. The second memory controller 122C-1, the second base interface area 122C-2, and the second base TSV area 122C-3 may be components that control an operation of a second group of channels (CH5 to CH8 in FIG. 14) included in the memory device 12C. Each of the first memory controller 121C-1, the first base interface area 121C-2, and the first base TSV area 121C-3, and the second memory controller 122C-1, the second base interface area 122C-2, and the second base TSV area 122C-3 may be implemented with the memory controller 121C, the base interface area 122C, and the base TSV area 123C illustrated in FIG. 11.

The first memory controller 121C-1, the first base interface area 121C-2, the first base TSV area 121C-3, the second memory controller 122C-1, the second base interface area 122C-2, and the second base TSV area 122C-3 may be disposed in the horizontal direction (i.e., X direction) of the control device 11C.

The first memory controller 121C-1 may be electrically connected to the first internal input and output line MIO1. The first memory controller 121C-1 may receive the command CMD and the data DATA that control an operation of the first group of channels (CH1 to CH4 in FIG. 14) included in the memory device 12C through the first internal input and output line MIO1. The first memory controller 121C-1 may output the command CMD and the data DATA that control an operation of the first group of channels (CH1 to CH4 in FIG. 14) included in the memory device 12C. The first memory controller 121C-1 may receive the data DATA from the first base interface area 121C-2 and output the data DATA to the first internal input and output line MIO1.

The first base interface area 121C-2 may be electrically connected to the first memory controller 121C-1. The first base interface area 121C-2 may receive the command CMD and the data DATA from the first memory controller 121C-1. The first base interface area 121C-2 may output the command CMD and the data DATA to the first base TSV area 121C-3 by adjusting the input and output sequence of the command CMD and the data DATA. The first base interface area 121C-2 may receive the data DATA from the first base TSV area 121C-3 and output the data DATA to the first memory controller 121C-1.

The first base TSV area 121C-3 may be electrically connected to the first base interface area 121C-2. The first base TSV area 121C-3 may receive the command CMD and the data DATA from the first base interface area 121C-2. The first base TSV area 121C-3 may output the command CMD and the data DATA to a first core TSV area (1^{st} CORE TSV PHY) (210C in FIG. 14) included in the memory device 12C through a plurality of TSVs. The first base TSV area 121C-3 may receive the data DATA from the memory device 12C and output the data DATA to the first base interface area 121C-2.

The first memory controller 121C-1, the first base interface area 121C-2, and the first base TSV area 121C-3 may be sequentially disposed in a first direction D1 from the central area CENTER of the control device 11C. The first direction D1 may be set as a direction from the central area CENTER to a first edge area TOP. The first edge area TOP may be set as an upper area of the control device 11C in a Y axis.

The second memory controller 122C-1 may be electrically connected to the second internal input and output line MIO2. The second memory controller 122C-1 may receive the command CMD and the data DATA that control an operation of the second group of channels (CH5 to CH8 in FIG. 14) included in the memory device 12C through the second internal input and output line MIO2. The second memory controller 122C-1 may output the command CMD and the data DATA that control an operation of the second group of channels (CH5 to CH8 in FIG. 14) included in the memory device 12C. The second memory controller 122C-1 may receive the data DATA from the second base interface area 122C-2 and output the data DATA to the second internal input and output line MIO2.

The second base interface area 122C-2 may be electrically connected to the second memory controller 122C-1. The second base interface area 122C-2 may receive the command CMD and the data DATA from the second memory controller 122C-1. The second base interface area 122C-2 may output the command CMD and the data DATA to the second base TSV area 122C-3 by adjusting the input and output sequence of the command CMD and the data DATA. The second base interface area 122C-2 may receive the data DATA from the second base TSV area 122C-3 and output the data DATA to the second memory controller 121C-2.

The second base TSV area 122C-3 may be electrically connected to the second base interface area 122C-2. The second base TSV area 122C-3 may receive the command CMD and the data DATA from the second base interface area 122C-2. The second base TSV area 122C-3 may output the command CMD and the data DATA to a second core TSV area (2^{nd} CORE TSV PHY) (220C in FIG. 14) included in the memory device 12C through a plurality of TSVs. The second base TSV area 122C-3 may receive the data DATA from the memory device 12C and output the data DATA to the second base interface area 122C-2.

The second memory controller 122C-1, the second base interface area 122C-2, and the second base TSV area 122C-3 may be sequentially disposed in a second direction D2 from the central area CENTER of the control device 11C. The second direction D2 may be set as a direction from the central area CENTER to a second edge area BOTTOM. The second edge area BOTTOM may be set as a lower area of the control device 11C in the Y axis.

The second area 120C may be set as an area that receives the command CMD and the data DATA from the first area 110C and outputs the command CMD and the data DATA to the memory device 12C. The second area 120C may be disposed in the central area CENTER of the control device 11C in the X axis.

The third area 130C may include a second internal interface (2^{nd} INT IF) area 131C and a second physical area (2^{nd} D2D PHY) 132C.

The second internal interface area 131C may receive the command CMD and the data DATA from the first internal input and output line MIO1. The second internal interface area 131C may output the command CMD and the data DATA received through the first internal input and output line MIO1 to the second physical area 132C by adjusting the input and output sequence of the command CMD and the data DATA. The second internal interface area 131C may receive the command CMD and the data DATA from the second internal input and output line MIO2. The second internal interface area 131C may output the command CMD and the data DATA received through the second internal input and output line MIO2 to the second physical area 132C by adjusting the input and output sequence of the command CMD and the data DATA. The second internal interface area 131C may be implemented in a network-on-chip (NoC).

The second physical area 132C may receive the command CMD and the data DATA from the second internal interface area 131C. The second physical area 132C may output the command CMD that is received as a transfer command TC. The second physical area 132C may output the data DATA that are received as transfer data TD. The second physical area 132C may output the transfer command TC and the transfer data TD to another HBM device and the process circuit (PRC CT in FIGS. 9 and 10).

The third area 130C may be set as an area that receives the command CMD and the data DATA from the second area 120C. The third area 130C may be set as an area that inputs and outputs the transfer command TC and the transfer data TD that are generated from the command CMD and the data DATA that are received. The third area 130C may be set as an area that inputs and outputs the command CMD and the data DATA to and from another HBM device, the process circuit, or an external device. The third area 130C may be disposed in a right area RIGHT of the control device 11C in the X axis.

In FIG. 12, the first internal interface area 112C, the second internal interface area 131C, the first internal input and output line MIO1, and the second internal input and output line MIO2 that are implemented in the network-on-chip (NoC) may be implemented in a first form. The first form means a form in which the first internal input and output line MIO1 and the second internal input and output line MIO2 that are implemented in the horizontal direction of the control device 11C in the X axis direction are disposed between the first internal interface area 112C and the second internal interface area 131C that are implemented in the vertical direction of the control device 11C in the Y axis direction.

In the first form, the first memory controller 121C-1, the first base interface area 121C-2, and the first base TSV area 121C-3 may be sequentially disposed in the first direction D1 from the central area CENTER in which the first internal input and output line MIO1 is disposed. In the first form, the second memory controller 122C-1, the second base interface area 122C-2, and the second base TSV area 122C-3 may be sequentially disposed in the second direction D2 from the central area CENTER in which the second internal input and output line MIO2 is disposed.

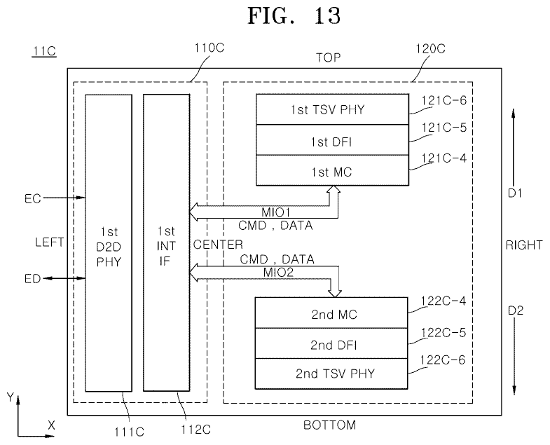

FIG. 13 is a block diagram illustrating a construction of the control device 11C according to an embodiment of the present disclosure. As illustrated in FIG. 13, the control device 11C may include a first area 110C and a second area 120C.

The first area 110C may include a first physical area (1^{st} D2D PHY) 111C and a first internal interface area (1^{st} INT IF) 112C.

The first physical area 111C and the first internal interface area 112C have the same constructions as the first physical area 111C and the first internal interface area 112C illustrated in FIG. 12, and thus detailed descriptions thereof are omitted.

A first internal input and output line MIO1 illustrated in FIG. 13 is connected between the first internal interface area 112C and a first memory controller (1^{st} MC) 121C-4 differently from the first internal input and output line MIO1 illustrated in FIG. 12, and may input and output a command CMD and data DATA. A second internal input and output line MIO2 illustrated in FIG. 13 is connected between the first internal interface area 112C and a second memory controller (2^{nd} MC) 122C-4 differently from the second internal input and output line MIO2 illustrated in FIG. 12, and may input and output a command CMD and data DATA. The first internal input and output line MIO1 and the second internal input and output line MIO2 may be implemented in a network-on-chip (NoC).

The first area 110C may be set as an area that generates a command CMD and data DATA and inputs and outputs the command CMD and the data DATA. Heat may be generated when the first area 110C inputs and outputs the command CMD and the data DATA. The first area 110C may be disposed in a left area LEFT of the control device 11C in an X axis.

The second area 120C may include the first memory controller 121C-4, a first base interface area (1^{st} DFI) 121C-5, a first base TSV area (1^{st} TSV PHY) 121C-6, the second memory controller 122C-4, a second base interface area (2^{nd} DFI) 122C-5, and a second base TSV area (2^{nd} TSV PHY) 122C-6 that control an operation of the memory device 12C.

The first memory controller 121C-4, the first base interface area 121C-5, the first base TSV area 121C-6, the second memory controller 122C-4, the second base interface area 122C-5, and the second base TSV area 122C-6 have the same constructions as the first memory controller 121C-1, the first base interface area 121C-2, the first base TSV area 121C-3, the second memory controller 122C-1, the second base interface area 122C-2, and the second base TSV area 122C-3 illustrated in FIG. 12, and thus detailed descriptions thereof are omitted.

The second area 120C may be set as an area that receives the command CMD and the data DATA from the first area 110C and outputs the command CMD and the data DATA to the memory device 12C. The second area 120C may be disposed in a right area RIGHT of the control device 11C in the X axis.

In FIG. 13, the first internal interface area 112C, the first internal input and output line MIO1, and the second internal input and output line MIO2 that are implemented in the network-on-chip (NoC) may be implemented in a second form. The second form means a form in which the first internal interface area 112C that is implemented in the vertical direction of the control device 11C in a Y axis direction and the first internal input and output line MIO1 and the second internal input and output line MIO2 that are implemented in the horizontal direction of the control device 11C in the X axis direction are disposed.

In the second form, the first memory controller 121C-4, the first base interface area 121C-5, and the first base TSV area 121C-6 may be sequentially disposed in a first direction D1 from the central area CENTER in which the first internal input and output line MIO1 is disposed. In the second form, the second memory controller 122C-4, the second base interface area 122C-5, and the second base TSV area 122C-6 may be sequentially disposed in a second direction D2 from the central area CENTER in which the second internal input and output line MIO2 is disposed.

Although not illustrated, in an embodiment, the first area 110C may be disposed in the right area RIGHT of the control device 11C in the X axis. Accordingly, the second area 120C that controls an operation of the memory device 12C is disposed in the left area LEFT of the control device in the X axis and may have the internal interface area 112C, the first internal input and output line MIO1, and the second internal input and output line MIO2 connected thereto, thus implementing a network-on-chip (NoC).

FIG. 14 is a block diagram illustrating a construction of the memory device 12C according to an embodiment of the present disclosure.

The memory device 12C may include the first to eighth channels CH1 to CH8, the first core TSV area 210C, and the second core TSV area 220C.

The first to eighth channels CH1 to CH8 may each receive a command CMD and data DATA by independently performing internal operations. The first to eighth channels CH1 to CH8 may each store the data DATA based on the command CMD after the start of a write operation of an internal operation. The first to eighth channels CH1 to CH8 may each output the data DATA based on the command CMD after the start of a read operation of an internal operation.

The first to fourth channels CH1 to CH4 may be electrically connected to the first core TSV area 210C. The first to fourth channels CH1 to CH4 may receive the command CMD and the data DATA from the first core TSV area 210C. The first to fourth channels CH1 to CH4 may output the data DATA to the first core TSV area 210C. The first to fourth channels CH1 to CH4 may each store the data DATA based on the command CMD after the start of a write operation of an internal operation. The first to fourth channels CH1 to CH4 may each output the data DATA based on the command CMD after the start of a read operation of an internal operation. The first to fourth channels CH1 to CH4 may be set as the first group of channels.

The fifth to eighth channels CH5 to CH8 may be electrically connected to the second core TSV area 220C. The fifth to eighth channels CH5 to CH8 may receive a command CMD and data DATA from the second core TSV area 220C. The fifth to eighth channels CH5 to CH8 may output the data DATA to the second core TSV area 220C. The fifth to eighth channels CH5 to CH8 may each store the data DATA based on the command CMD after the start of a write operation of an internal operation. The fifth to eighth channels CH5 to CH8 may each output the data DATA based on the command CMD after the start of a read operation of an internal operation. The fifth to eighth channels CH5 to CH8 may be set as the second group of channels.

The first to fourth channels CH1 to CH4 may be disposed in a central area CENTER of the memory device 12C. The fifth to eighth channels CH5 to CH8 may be disposed in the central area CENTER of the memory device 12C.

The first core TSV area 210C may be electrically connected to the first base TSV area 121C-3, 121C-6 of the control device 11C. The first core TSV area 210C may receive the command CMD and the data DATA from the first base TSV area 121C-3, 121C-6. The first core TSV area 210C may receive the command CMD and the data DATA through a plurality of TSVs. The first core TSV area 210C may output the command CMD and the data DATA to the first to fourth channels CH1 to CH4. The first core TSV area 210 may receive the data DATA from the first to fourth channels CH1 to CH4 and output the data DATA to the first base TSV area 121C-3, 121C-6. The first core TSV area 210C may be disposed in a first direction D1 from the central area CENTER. The first direction D1 may be set as a direction from the central area CENTER to a first edge area TOP. The first edge area TOP may be set as an upper area of the memory device 12C in a Y axis.

The second core TSV area 220C may be electrically connected to the second base TSV area 122C-3, 122C-6 of the control device 11C. The second core TSV area 220C may receive a command CMD and data DATA from the second base TSV area 122C-3, 122C-6. The second core TSV area 220C may receive the command CMD and the data DATA through a plurality of TSVs. The second core TSV area 220C may output the command CMD and the data DATA to the fifth to eighth channels CH5 to CH8. The second core TSV area 220C may receive the data DATA from the fifth to eighth channels CH5 to CH8 and output the data DATA to the second base TSV area 122C-3, 122C-6. The second core TSV area 220C may be disposed in a second direction D2 from the central area CENTER. The second direction D2 may be set as a direction from the central area CENTER to a second edge area BOTTOM. The second edge area BOTTOM may be set as a lower area of the memory device 12C in the Y axis.

The HBM device 7C according to an embodiment of the present disclosure can prevent a phenomenon in which generated heat is diffused to a memory device because the memory device is not stacked on an area from which the heat is generated due to the input and output of the command CMD and the data DATA. The HBM device 7C according to an embodiment of the present disclosure can facilitate the discharge of heat because a dummy die group is stacked on an area from which the heat is generated due to the input and output of the command CMD and the data DATA.

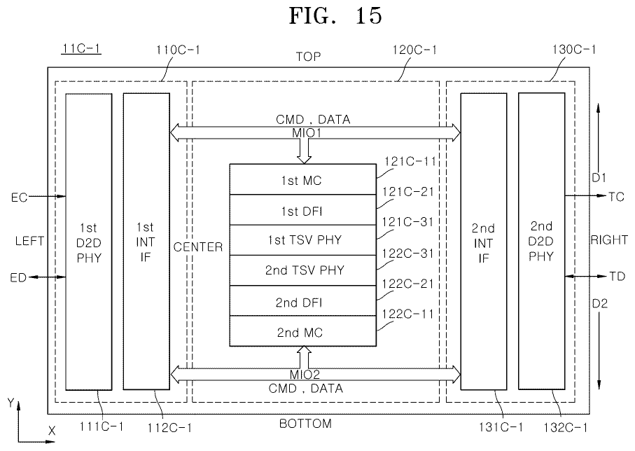

FIG. 15 is a block diagram illustrating a construction of a control device 11C-1 according to an embodiment of the present disclosure. As illustrated in FIG. 15, the control device 11C-1 may include a first area 110C-1, a second area 120C-1, and a third area 130C-1.

The first area 110C-1 may include a first physical area (1^{st} D2D PHY) 111C-1 and a first internal interface area (1^{st} INT IF) 112C-1.

The first physical area 111C-1 may generate a command CMD by receiving an external command EC from the process circuit (PRC CT in FIGS. 9 and 10). The first physical area 111C-1 may generate the command CMD by buffering or decoding the external command EC. The external command EC and the command CMD are each illustrated as only one signal, but may each include a plurality of bits. The first physical area 111C-1 may generate data DATA by receiving external data ED from the process circuit (PRC CT in FIGS. 9 and 10). The first physical area 111C-1 may generate the external data ED by receiving the data DATA from the first internal interface area 112C-1. The first physical area 111C-1 may output the external data ED to the process circuit (PRC CT in FIGS. 9 and 10). The external data ED and the data DATA are each illustrated as only one signal, but may each include a plurality of bits.

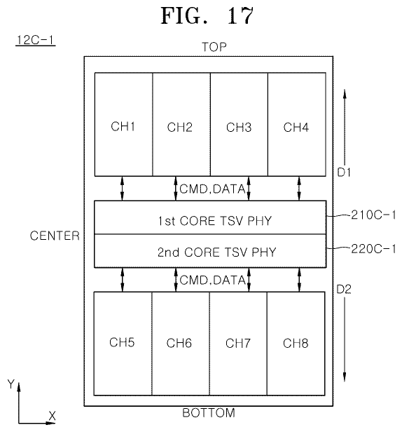

The first internal interface area 112C-1 may receive the command CMD and the data DATA from the first physical area 111C-1. The first internal interface area 112C-1 may output the command CMD and the data DATA that control an operation of the memory device (12C-1 in FIG. 15) to a first internal input and output line MIO1 by adjusting the input and output sequence of the command CMD and the data DATA. The first internal interface area 112C-1 may output the command CMD and the data DATA that controls an operation of the memory device (12C-1 in FIG. 17) to the second internal input and output line MIO2 by adjusting the input and output sequence of the command CMD and the data DATA. The first internal input and output line MIO1 may be disposed in a first edge area TOP of the control device 11C-1. The second internal input and output line MIO2 may be disposed in a second edge area BOTTOM of the control device 11C-1. The first internal interface area 112C-1, the first internal input and output line MIO1, and a second internal input and output line MIO2 may be implemented in a network-on-chip (NoC).

The first area 110C-1 may be set as an area that generates a command CMD and data DATA and inputs and outputs the command CMD and the data DATA. Heat may be generated when the first area 110C-1 inputs and outputs the command CMD and the data DATA. The first area 110C-1 may be disposed in a left area LEFT of the control device 11C-1 in an X axis.

The second area 120C-1 may include a first memory controller (1^{st} MC) 121C-11, a first base interface area (1^{st} DFI) 121C-21, a first base TSV area (1^{st} TSV PHY) 121C-31, a second memory controller (2^{nd} MC) 122C-11, a second base interface area (2^{nd} DFI) 122C-21 and a second base TSV area (2^{nd} TSV PHY) 122C-31 that control an operation of the memory device 12C. The first memory controller 121C-11, the first base interface area 121C-21, and the first base TSV area 121C-31 may be components that control an operation of a first group of channels (CH1 to CH4 in FIG. 17) included in a memory device (12C-1 in FIG. 17). The second memory controller 122C-11, the second base interface area 122C-21, and the second base TSV area 122C-31 may be components that control an operation of a second group of channels (CH5 to CH8 in FIG. 17) included in the memory device (12C-1 in FIG. 17). Each of the first memory controller 121C-11, the first base interface area 121C-21, and the first base TSV area 121C-31, and the second memory controller 122C-11, the second base interface area 122C-21, and the second base TSV area 122C-31 may be implemented with the memory controller 121C, the base interface area 122C, and the base TSV area 123C illustrated in FIG. 11.

The first memory controller 121C-11, the first base interface area 121C-21, the first base TSV area 121C-31, the second memory controller 122C-11, the second base interface area 122C-21, and the second base TSV area 122C-31 may be disposed in the horizontal direction (i.e., X direction) of the control device 11C-1.

The first memory controller 121C-11 may be electrically connected to the first internal input and output line MIO1. The first memory controller 121C-11 may receive the command CMD and the data DATA that control an operation of the first group of channels (CH1 to CH4 in FIG. 17) included in the memory device (12C-1 in FIG. 17) through the first internal input and output line MIO1. The first memory controller 121C-11 may output the command CMD and the data DATA that control an operation of the first group of channels (CH1 to CH4 in FIG. 17) included in the memory device (12C-1 in FIG. 17). The first memory controller 121C-11 may receive the data DATA from the first base interface area 121C-21 and output the data DATA to the first internal input and output line MIO1.

The first base interface area 121C-21 may be electrically connected to the first memory controller 121C-11. The first base interface area 121C-21 may receive the command CMD and the data DATA from the first memory controller 121C-11. The first base interface area 121C-21 may output the command CMD and the data DATA to the first base TSV area 121C-31 by adjusting the input and output sequence of the command CMD and the data DATA. The first base interface area 121C-21 may receive the data DATA from the first base interface area 121C-31 and output the data DATA to the first memory controller 121C-11.

The first base TSV area 121C-31 may be electrically connected to the first base interface area 121C-21. The first base TSV area 121C-31 may receive the command CMD and the data DATA from the first base interface area 121C-21. The first base TSV area 121C-31 may output the command CMD and the data DATA to a first core TSV area (1^{st} CORE TSV PHY) (210C-1 in FIG. 17) included in the memory device (12C-1 in FIG. 17) through a plurality of TSVs. The first base TSV area 121C-31 may receive data DATA from the memory device (12C-1 in FIG. 17) and output the data DATA to the first base interface area 121C-21.

The first memory controller 121C-11, the first base interface area 121C-21, and the first base TSV area 121C-31 may be sequentially disposed in a second direction D2 from the first edge area TOP of the control device 11C-1. The second direction D2 may be set as a direction from the first edge area TOP to a central area CENTER. The first edge area TOP may be set as an upper area of the control device 11C-1 in a Y axis.

The second memory controller 122C-11 may be electrically connected to a second internal input and output line MIO2. The second memory controller 122C-11 may receive a command CMD and data DATA that control an operation of the second group of channels (CH5 to CH8 in FIG. 17) included in the memory device (12C-1 in FIG. 17) through the second internal input and output line MIO2. The second memory controller 122C-11 may output the command CMD and the data DATA that control an operation of the second group of channels (CH5 to CH8 in FIG. 17) included in the memory device (12C-1 in FIG. 17). The second memory controller 122C-11 may receive the data DATA from the second base interface area 122C-21 and output the data DATA to the second internal input and output line MIO2.

The second base interface area 122C-21 may be electrically connected to the second memory controller 122C-11. The second base interface area 122C-21 may receive the command CMD and the data DATA from the second memory controller 122C-11. The second base interface area 122C-21 may output the command CMD and the data DATA to the second base TSV area 122C-31 by adjusting the input and output sequence of the command CMD and the data DATA. The second base interface area 122C-21 may receive the data DATA from the second base TSV area 122C-31 and output the data DATA to the second memory controller 121C-21.

The second base TSV area 122C-31 may be electrically connected to the second base interface area 122C-21. The second base TSV area 122C-31 may receive the command CMD and the data DATA from the second base interface area 122C-21. The second base TSV area 122C-31 may output the command CMD and the data DATA to a second core TSV area (2^{nd} CORE TSV PHY) (220C-1 in FIG. 17) included in the memory device (12C-1 in FIG. 17) through a plurality of TSVs. The second base TSV area 122C-31 may receive the data DATA from the memory device (12C-1 in FIG. 17) and output the data DATA to the second base interface area 122C-21.

The second memory controller 122C-11, the second base interface area 122C-21, and the second base TSV area 122C-31 may be sequentially disposed in a first direction D1 from the second edge area BOTTOM of the control device 11C-1. The first direction D1 may be set as a direction from the second edge area BOTTOM to the central area CENTER. The second edge area BOTTOM may be set as a lower area of the control device 11C-1 in the Y axis.

The second area 120C-1 may be set as an area that receives the command CMD and the data DATA from the first area 110C-1 and outputs the command CMD and the data DATA to the memory device (12C-1 in FIG. 17). The second area 120C-1 may be disposed in the central area CENTER of the control device 11C-1 in the X axis.

The third area 130C-1 may include a second internal interface area (2^{nd} INT IF) 131C-1 and a second physical area (2^{nd} D2D PHY) 132C-1.

The second internal interface area 131C-1 may receive the command CMD and the data DATA from the first internal input and output line MIO1. The second internal interface area 131C-1 may output the command CMD and the data DATA received through the first internal input and output line MIO1 to the second physical area 132C-1 by adjusting the input and output sequence of the command CMD and the data DATA. The second internal interface area 131C-1 may receive the command CMD and the data DATA from the second internal input and output line MIO2. The second internal interface area 131C-1 may output the command CMD and the data DATA received through the second internal input and output line MIO2 to the second physical area 132C-1 by adjusting the input and output sequence of the command CMD and the data DATA. The second internal interface area 113C-1 may be implemented in a network-on-chip (NoC).

The second physical area 132C-1 may receive the command CMD and the data DATA from the second internal interface area 131C-1. The second physical area 132C-1 may output the command CMD that is received as a transfer command TC. The second physical area 132C-1 may output the data DATA that are received as transfer data TD. The second physical area 132C-1 may output the transfer command TC and the transfer data TD to another HBM device and the process circuit (PRC CT in FIGS. 9 and 10).

The third area 130C-1 may be set as an area that receives the command CMD and the data DATA from the second area 120C-1. The third area 130C-1 may be set as an area that inputs and outputs the transfer command TC and the transfer data TD that are generated from the command CMD and the data DATA that are received. The third area 130C-1 may be set as an area that inputs and outputs the command CMD and the data DATA to and from another HBM device, the process circuit, or an external device. The third area 130C-1 may be disposed in a right area RIGHT of the control device 11C-1 in the X axis.

In FIG. 15, the first internal interface area 112C-1, the second internal interface area 131C-1, the first internal input and output line MIO1, and the second internal input and output line MIO2 that are implemented in the network-on-chip (NoC) may be implemented in a first form. The first form means a form in which the first internal input and output line MIO1 and the second internal input and output line MIO2 that are implemented in the horizontal direction of the control device 11C-1 in the X axis direction are disposed between the first internal interface area 112C-1 and the second internal interface area 131C-1 that are implemented in the vertical direction of the control device 11C-1 in the Y axis direction.

In the first form, the first memory controller 121C-11, the first base interface area 121C-21, and the first base TSV area 121C-31 may be sequentially disposed in the second direction D2 from the first edge area TOP in which the first internal input and output line MIO1 is disposed. In the first form, the second memory controller 122C-11, the second base interface area 122C-21, and the second base TSV area 122C-31 may be sequentially disposed in the first direction D1 from the second edge area BOTTOM in which the second internal input and output line MIO2 is disposed.

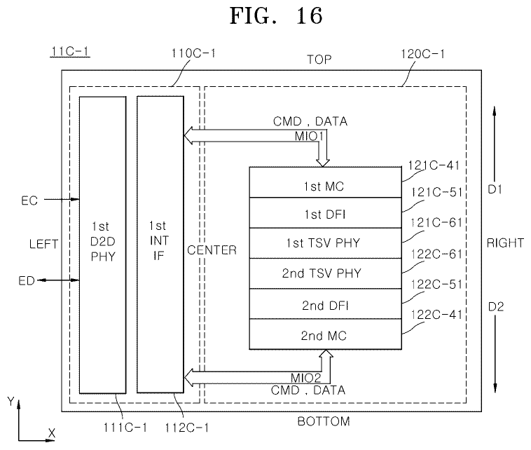

FIG. 16 is a block diagram illustrating a construction of the control device 11C according to an embodiment of the present disclosure. As illustrated in FIG. 16, a control device 11C-1 may include a first area 110C-1 and a second area 120C-1.

The first area 110C-1 may include a first physical area (1^{st} D2D PHY) 111C-1 and a first internal interface area (1^{st} INT IF) 112C-1.

The first physical area 111C-1 and the first internal interface area 112C-1 have the same construction as the first physical area 111C-1 and the first internal interface area 112C-1 illustrated in FIG. 15, and thus detailed descriptions thereof are omitted.

A first internal input and output line MIO1 illustrated in FIG. 16 is connected between the first internal interface area 112C-1 and a first memory controller (1^{st} MC) 121C-41 differently from the first internal input and output line MIO1 illustrated in FIG. 15, and may input and output a command CMD and data DATA. A second internal input and output line MIO2 illustrated in FIG. 16 is connected between the first internal interface area 112C-1 and a second memory controller (2^{nd} MC) 122C-41 differently from the second internal input and output line MIO2 illustrated in FIG. 15, and may input and output a command CMD and data DATA. The first internal interface area 112C-1, the first internal input and output line MIO1, and the second internal input and output line MIO2 may be implemented in a network-on-chip (NoC).

The first area 110C-1 may be set as an area that generates a command CMD and data DATA and inputs and outputs the command CMD and the data DATA. Heat may be generated when the first area 110C-1 inputs and outputs the command CMD and the data DATA. The first area 110C-1 may be disposed in a left area LEFT of the control device 11C-1 in an X axis.

The second area 120C-1 may include the first memory controller 121C-41, a first base interface area (1^{st} DFI) 121C-51, a first base TSV area (1^{st} TSV PHY) 121C-61, the second memory controller 122C-41, a second base interface area (2^{nd} DFI) 122C-51, and a second base TSV area (2^{nd} TSV PHY) 122C-61 that control an operation of the memory device 12C-1.

The first memory controller 121C-41, the first base interface area 121C-51, the first base TSV area 121C-61, the second memory controller 122C-41, the second base interface area 122C-51, and the second base TSV area 122C-61 have the same constructions as the first memory controller 121C-11, the first base interface area 121C-21, the first base TSV area 121C-31, the second memory controller 122C-11, the second base interface area 122C-21, and the second base TSV area 122C-31 illustrated in FIG. 15, and thus detailed descriptions thereof are omitted.

The second area 120C-1 may be set as an area that receives the command CMD and the data DATA from the first area 110C-1 and outputs the command CMD and the data DATA to the memory device 12C-1. The second area 120C-1 may be disposed in a right area RIGHT of the control device 11C-1 in the X axis.

The first internal interface area 112C-1, the first internal input and output line MIO1, and the second internal input and output line MIO2 that are implemented in the network-on-chip (NoC) and are illustrated in FIG. 16 may be implemented in a second form. The second form means a form in which the first internal interface area 112C-1 that is implemented in the vertical direction of the control device 11C-1 in a Y axis direction and the first internal input and output line MIO1 and the second internal input and output line MIO2 that are implemented in the horizontal direction of the control device 11C-1 in the X axis direction are disposed.

In the second form, the first memory controller 121C-41, the first base interface area 121C-51, and the first base TSV area 121C-61 may be sequentially disposed in a second direction D2 from a first edge area TOP in which the first internal input and output line MIO1 is disposed. In the second form, the second memory controller 122C-41, the second base interface area 122C-51, and the second base TSV area 122C-61 may be sequentially disposed in a first direction D1 from a second edge area BOTTOM in which the second internal input and output line MIO2 is disposed.

Although not illustrated, in an embodiment, the first area 110C-1 may be disposed in the right area RIGHT of the control device 11C-1 in the X axis. Accordingly, the second area 120C-1 that controls an operation of the memory device 12C-1 is disposed in the left area LEFT of the control device in the X axis. The internal interface area 112C-1, the first internal input and output line MIO1, the second internal input, and output line MIO2 may be connected to implement a network-on-chip (NoC).

FIG. 17 is a block diagram illustrating a construction of the memory device 12C-1 according to an embodiment of the present disclosure.

The memory device 12C-1 may include the first to eighth channels CH1 to CH8, the first core TSV area 210C-1, and the second core TSV area 220C-1.

The first to eighth channels CH1 to CH8 may each receive a command CMD and data DATA by independently performing internal operations. The first to eighth channels CH1 to CH8 may each store the data DATA based on the command CMD after the start of a write operation of an internal operation. The first to eighth channels CH1 to CH8 may each output the data DATA based on the command CMD after the start of a read operation of an internal operation.

The first to fourth channels CH1 to CH4 may be electrically connected to the first core TSV area 210C-1. The first to fourth channels CH1 to CH4 may receive the command CMD and the data DATA from the first core TSV area 210C-1. The first to fourth channels CH1 to CH4 may output the data DATA to the first core TSV area 210C-1. The first to fourth channels CH1 to CH4 may each store the data DATA based on the command CMD after the start of a write operation of an internal operation. The first to fourth channels CH1 to CH4 may each output the data DATA based on the command CMD after the start of a read operation of an internal operation. The first to fourth channels CH1 to CH4 may be set as the first group of channels.

The fifth to eighth channels CH5 to CH8 may be electrically connected to the second core TSV area 220C-1. The fifth to eighth channels CH5 to CH8 may receive a command CMD and data DATA from the second core TSV area 220C-1. The fifth to eighth channels CH5 to CH8 may output the data DATA to the second core TSV area 220C-1. The fifth to eighth channels CH5 to CH8 may each store the data DATA based on the command CMD after the start of a write operation of an internal operation. The fifth to eighth channels CH5 to CH8 may each output the data DATA based on the command CMD after the start of a read operation of an internal operation. The fifth to eighth channels CH5 to CH8 may be set as the second group of channels.

The first to fourth channels CH1 to CH4 may be disposed in a first edge area TOP of the memory device 12C-1. The fifth to eighth channels CH5 to CH8 may be disposed in a second edge area BOTTOM of the memory device 12C-1.

The first core TSV area 210C-1 may be electrically connected to the first base TSV area 121C-31, 121C-61 of the control device 11C-1. The first core TSV area 210C-1 may receive the command CMD and the data DATA from the first base TSV area 121C-31, 121C-61. The first core TSV area 210C-1 may receive the command CMD and the data DATA through a plurality of TSVs. The first core TSV area 210C-1 may output the command CMD and the data DATA to the first to fourth channels CH1 to CH4. The first core TSV area 210C-1 may receive the data DATA from the first to fourth channels CH1 to CH4 and output the data DATA to the first base TSV area 121C-31, 121C-61. The first core TSV area 210C-1 may be disposed in a central area CENTER. The first core TSV area 210C-1 may be disposed in a second direction D2 from the first edge area TOP. The second direction D2 may be set as a direction from the first edge area TOP to the central area CENTER. The first edge area TOP may be set as an upper area of the memory device 12C-1 in a Y axis.

The second core TSV area 220C-1 may be electrically connected to the second base TSV area 122C-31, 122C-61 of the control device 11C-1. The second core TSV area 220C-1 may receive the command CMD and the data DATA from the second base TSV area 122C-31, 122C-61. The second core TSV area 220C-1 may receive the command CMD and the data DATA through a plurality of TSVs. The second core TSV area 220C-1 may output the command CMD and the data DATA to the fifth to eighth channels CH5 to CH8. The second core TSV area 220C-1 may receive the data DATA from the fifth to eighth channels CH5 to CH8 and output the data DATA to the second base TSV area 122C-31, 122C-61. The second core TSV area 220C-1 may be disposed in the central area CENTER. The second core TSV area 220C-1 may be disposed in a first direction D1 from the second edge area BOTTOM. The first direction D1 may be set as a direction from the second edge area BOTTOM to the central area CENTER. The second edge area BOTTOM may be set as a lower area of the memory device 12C-1 in the Y axis.

The HBM device 7C according to an embodiment of the present disclosure can prevent a phenomenon in which generated heat is diffused to a memory device because the memory device is not stacked on an area from which the heat is generated due to the input and output of the command CMD and the data DATA. The HBM device 7C according to an embodiment of the present disclosure can facilitate the discharge of heat because a dummy die group is stacked on an area from which the heat is generated due to the input and output of the command CMD and the data DATA.

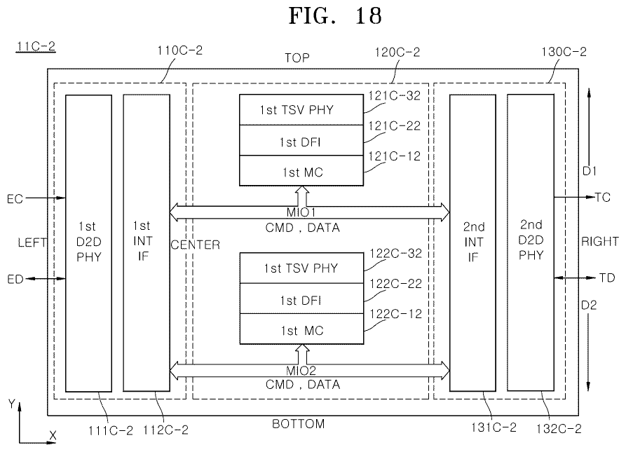

FIG. 18 is a block diagram illustrating a construction of a control device 11C-2 according to an embodiment of the present disclosure. As illustrated in FIG. 18, the control device 11C-2 may include a first area 110C-2, a second area 120C-2, and a third area 130C-2.

The first area 110C-2 may include a first physical area (1^{st} D2D PHY) 111C-2 and a first internal interface area (1^{st} INT IF) 112C-2.

The first physical area 111C-2 may generate a command CMD by receiving an external command EC from the process circuit (PRC CT in FIGS. 9 and 10). The first physical area 111C-2 may generate the command CMD by buffering or decoding the external command EC. The external command EC and the command CMD are each illustrated as only one signal, but may each include a plurality of bits. The first physical area 111C-2 may generate data DATA by receiving external data ED from the process circuit (PRC CT in FIGS. 9 and 10). The first physical area 111C-2 may generate the external data ED by receiving data DATA from the first internal interface area 112C-2. The first physical area 111C-2 may output the external data ED to the process circuit (PRC CT in FIGS. 9 and 10). The external data ED and the data DATA are each illustrated as only one signal, but may each include a plurality of bits.

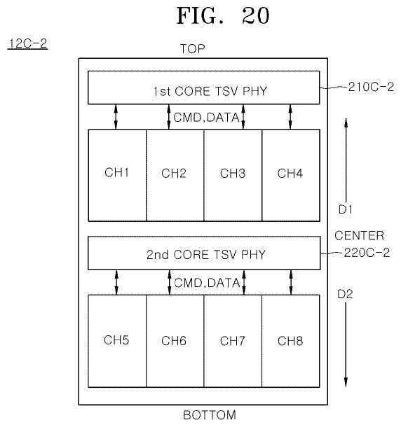

The first internal interface area 112C-2 may receive the command CMD and the data DATA from the first physical area 111C-2. The first internal interface area 112C-2 may output the command CMD and the data DATA that control an operation of the memory device (12C-2 in FIG. 20) to a first internal input and output line MIO1 by adjusting the input and output sequence of the command CMD and the data DATA. The first internal interface area 112C-2 may output the command CMD and the data DATA that control an operation of the memory device (12C-2 in FIG. 20) to a second internal input and output line MIO2 by adjusting the input and output sequence of the command CMD and the data DATA. The first internal input and output line MIO1 may be disposed in a central area CENTER of the control device 111C-2. The second internal input and output line MIO2 may be disposed in a second edge area BOTTOM of the control device 11C-2. The first internal interface area 112C-2, the first internal input and output line MIO1, and the second internal input and output line MIO2 may be implemented in a network-on-chip (NoC).

The first area 110C-2 may be set as an area that generates a command CMD and data DATA and inputs and outputs the command CMD and the data DATA. Heat may be generated when the first area 110C-2 inputs and outputs the command CMD and the data DATA. The first area 110C-12 may be disposed in a left area LEFT of the control device 11C-2 in an X axis.

The second area 120C-2 may include a first memory controller (1^{st} MC) 121C-12, a first base interface area (1^{st} DFI) 121C-22, a first base TSV area (1^{st} TSV PHY) 121C-32, a second memory controller (2^{nd} MC) 122C-12, a second base interface area (2^{nd} DFI) 122C-22, and a second base TSV area (2^{nd} TSV PHY) 122C-32 that control an operation of the memory device (12C-2 in FIG. 20). The first memory controller 121C-12, the first base interface area 121C-22, and the first base TSV area 121C-32 may be components that control an operation of a first group of channels (CH1 to CH4 in FIG. 20) included in the memory device (12C-2 in FIG. 20). The second memory controller 122C-12, the second base interface area 122C-22, and the second base TSV area 122C-32 may be components that control an operation of a second group of channels (CH5 to CH8 in FIG. 20) included in the memory device (12C-2 in FIG. 20). Each of the first memory controller 121C-12, the first base interface area 121C-22, and the first base TSV area 121C-32, and the second memory controller 122C-12, the second base interface area 122C-22, and the second base TSV area 122C-32 may be implemented with the memory controller 121C, the base interface area 122C, and the base TSV area 123C illustrated in FIG. 11.

The first memory controller 121C-12, the first base interface area 121C-22, the first base TSV area 121C-32, the second memory controller 122C-12, the second base interface area 122C-22, and the second base TSV area 122C-32 may be disposed in the horizontal direction (i.e., X direction) of the control device 11C-2.

The first memory controller 121C-12 may be electrically connected to the first internal input and output line MIO1. The first memory controller 121C-12 may receive a command CMD and data DATA that control an operation of the first group of channels (CH1 to CH4 in FIG. 20) included in the memory device (12C-2 in FIG. 20) through the first internal input and output line MIO1. The first memory controller 121C-12 may output the command CMD and the data DATA that control an operation of the first group of channels (CH1 to CH4 in FIG. 20) included in the memory device (12C-2 in FIG. 20). The first memory controller 121C-12 may receive the data DATA from the first base interface area 121C-22 and output the data DATA to the first internal input and output line MIO1.

The first base interface area 121C-22 may be electrically connected to the first memory controller 121C-12. The first base interface area 121C-22 may receive the command CMD and the data DATA from the first memory controller 121C-12. The first base interface area 121C-22 may output the command CMD and the data DATA to the first base TSV area 121C-32 by adjusting the input and output sequence of the command CMD and the data DATA. The first base interface area 121C-22 may receive the data DATA from the first base TSV area 121C-32 and output the data DATA to the first memory controller 121C-12.

The first base TSV area 121C-32 may be electrically connected to the first base interface area 121C-22. The first base TSV area 121C-32 may receive the command CMD and the data DATA from the first base interface area 121C-22. The first base TSV area 121C-32 may output the command CMD and the data DATA to a first core TSV area (1^{st} CORE TSV PHY) (210C-2 in FIG. 20) included in the memory device (12C-2 in FIG. 20) through a plurality of TSVs. The first base TSV area 121C-32 may receive data DATA from the memory device (12C-2 in FIG. 20) and output the data DATA to the first base interface area 121C-22.

The first memory controller 121C-12, the first base interface area 121C-22, and the first base TSV area 121C-32 may be sequentially disposed in a first direction D1 from the central area CENTER of the control device 11C-2. The first direction D1 may be set as a direction from the central area CENTER to a first edge area TOP. The first edge area TOP may be set as an upper area of the control device 11C-2 in a Y axis.

The second memory controller 122C-12 may be electrically connected to the second internal input and output line MIO2. The second memory controller 122C-12 may receive a command CMD and data DATA that control an operation of the second group of channels (CH5 to CH8 in FIG. 20) included in the memory device (12C-2 in FIG. 20) through the second internal input and output line MIO2. The second memory controller 122C-12 may output the command CMD and the data DATA that control an operation of the second group of channels (CH5 to CH8 in FIG. 20) included in the memory device (12C-2 in FIG. 20). The second memory controller 122C-12 may receive the data DATA from the second base interface area 122C-22 and output the data DATA to the second internal input and output line MIO2.

The second base interface area 122C-22 may be electrically connected to the second memory controller 122C-12. The second base interface area 122C-22 may receive the command CMD and the data DATA from the second memory controller 122C-12. The second base interface area 122C-22 may output the command CMD and the data DATA to the second base TSV area 122C-32 by adjusting the input and output sequence of the command CMD and the data DATA. The second base interface area 122C-22 may receive the data DATA from the second base TSV area 122C-32 and output the data DATA to the second memory controller 121C-22.

The second base TSV area 122C-32 may be electrically connected to the second base interface area 122C-22. The second base TSV area 122C-32 may receive the command CMD and the data DATA from the second base interface area 122C-22. The second base TSV area 122C-32 may output the command CMD and the data DATA to a second core TSV area (2^{nd} CORE TSV PHY) (220C-2 in FIG. 20) included in the memory device (12C-2 in FIG. 20) through a plurality of TSVs. The second base TSV area 122C-32 may receive the data DATA from the memory device (12C-2 in FIG. 20) and output the data DATA to the second base interface area 122C-22.

The second memory controller 122C-12, the second base interface area 122C-22, and the second base TSV area 122C-32 may be sequentially disposed in the first direction D1 from the second edge area BOTTOM of the control device 11C-2. The first direction D1 may be set as a direction from the second edge area BOTTOM to the central area CENTER. The second edge area BOTTOM may be set as a lower area of the control device 11C-2 in the Y axis.

The second area 120C-2 may be set as an area that receives the command CMD and the data DATA from the first area 110C-2 and outputs the command CMD and the data DATA to the memory device (12C-2 in FIG. 20). The second area 120C-2 may be disposed in the central area CENTER of the control device 11C-2 in the X axis.

The third area 130C-2 may include a second internal interface area (2^{nd} INT IF) 131C-2 and a second physical area (2^{nd} D2D PHY) 132C-2.

The second internal interface area 131C-2 may receive the command CMD and the data DATA from the first internal input and output line MIO1. The second internal interface area 131C-2 may output the command CMD and the data DATA received through the first internal input and output line MIO1 to the second physical area 132C-2 by adjusting the input and output sequence of the command CMD and the data DATA. The second internal interface area 131C-2 may receive the command CMD and the data DATA from the second internal input and output line MIO2. The second internal interface area 131C-2 may output the command CMD and the data DATA received through the second internal input and output line MIO2 to the second physical area 132C-2 by adjusting the input and output sequence of the command CMD and the data DATA. The second internal interface area 131C-2 may be implemented in a network-on-chip (NoC).

The second physical area 132C-2 may receive the command CMD and the data DATA from the second internal interface area 131C-2. The second physical area 132C-2 may output the command CMD that is received as a transfer command TC. The second physical area 132C-2 may output the data DATA that are received as transfer data TD. The second physical area 132C-2 may output the transfer command TC and the transfer data TD to another HBM device and the process circuit (PRC CT in FIGS. 9 and 10).

The third area 130C-2 may be set as an area that receives the command CMD and the data DATA from the second area 120C-2. The third area 130C-2 may be set as an area that inputs and outputs the transfer command TC and the transfer data TD that are generated from the command CMD and the data DATA that are received. The third area 130C-2 may be set as an area that inputs and outputs the command CMD and the data DATA to and from another HBM device, the process circuit, or an external device. The third area 130C-2 may be disposed in a right area RIGHT of the control device 11C-2 in the X axis.

In FIG. 18, the first internal interface area 112C-2, the second internal interface area 131C-2, the first internal input and output line MIO1, and the second internal input and output line MIO2 that are implemented in the network-on-chip (NoC) may be implemented in a first form. The first form means a form in which the first internal input and output line MIO1 and the second internal input and output line MIO2 that are implemented in the horizontal direction of the control device 11C-2 in the X axis direction are disposed between the first internal interface area 112C-2 and the second internal interface area 131C-2 that are implemented in the vertical direction of the control device 11C-2 in the Y axis direction.

In the first form, the first memory controller 121C-12, the first base interface area 121C-22, and the first base TSV area 121C-32 may be sequentially disposed in the first direction D1 from the central area CENTER in which the first internal input and output line MIO1 is disposed. In the first form, the second memory controller 122C-12, the second base interface area 122C-22, and the second base TSV area 122C-32 may be sequentially disposed in the first direction D1 from the second edge area BOTTOM in which the second internal input and output line MIO2 is disposed.

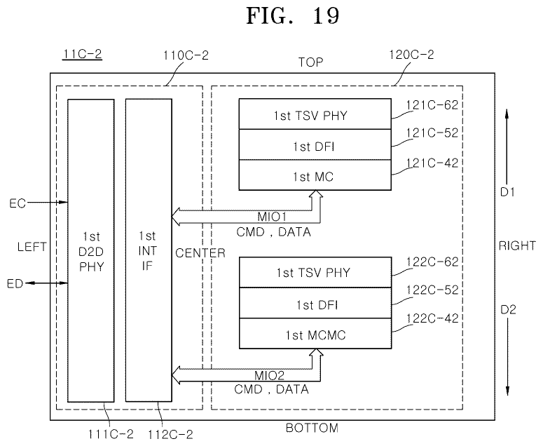

FIG. 19 is a block diagram illustrating a construction of the control device 11C according to an embodiment of the present disclosure. As illustrated in FIG. 19, the control device 11C-2 may include a first area 110C-2 and a second area 120C-2.

The first area 110C-2 may include a first physical area (1^{st} D2D PHY) 111C-2 and a first internal interface area (1^{st} INT IF) 112C-2.

The first physical area 111C-2 and the first internal interface area 112C-2 have the same constructions as the first physical area 111C-2 and the first internal interface area 112C-2 illustrated in FIG. 18, and thus detailed descriptions thereof are omitted.

A first internal input and output line MIO1 illustrated in FIG. 19 is connected between the first internal interface area 112C-2 and a first memory controller (1^{st} MC) 121C-42 differently from the first internal input and output line MIO1 illustrated in FIG. 18, and may input and output a command CMD and data DATA. A second internal input and output line MIO2 illustrated in FIG. 19 is connected between the first internal interface area 112C-2 and a second memory controller (2^{nd} MC) 122C-42 differently from the second internal input and output line MIO2 illustrated in FIG. 18, and may input and output a command CMD and the data DATA. The first internal interface area 112C-2, the first internal input and output line MIO1 and the second internal input and output line MIO2 may be implemented in a network-on-chip (NoC).

The first area 110C-2 may be set as an area that generates a command CMD and data DATA and inputs and outputs the command CMD and the data DATA. Heat may be generated when the first area 110C-2 inputs and outputs the command CMD and the data DATA. The first area 110C-2 may be disposed in a left area LEFT of the control device 11C-2 in an X axis.

The second area 120C-2 may include the first memory controller 121C-42, a first base interface area (1^{st} DFI) 121C-52, a first base TSV area (1^{st} TSV PHY) 121C-62, the second memory controller 122C-42, a second base interface area (2^{nd} DFI) 122C-52, and a second base TSV area (2^{nd} TSV PHY) 122C-62 that control an operation of the memory device 12C-2.

The first memory controller 121C-42, the first base interface area 121C-52, the first base TSV area 121C-62, the second memory controller 122C-42, the second base interface area 122C-52, and the second base TSV area 122C-62 have the same construction as the first memory controller 121C-12, the first base interface area 121C-22, the first base TSV area 121C-32, the second memory controller 122C-12, the second base interface area 122C-22, and the second base TSV area 122C-32 illustrated in FIG. 18, and thus detailed descriptions thereof are omitted.

The second area 120C-2 may be set as an area that receives the command CMD and the data DATA from the first area 110C-2 and outputs the command CMD and the data DATA to the memory device 12C-2. The second area 120C-2 may be disposed in a right area RIGHT of the control device 11C-2 in the X axis.

The first internal interface area 112C-2, the first internal input and output line MIO1, and the second internal input and output line MIO2 that are implemented in the network-on-chip (NoC), which are illustrated in FIG. 19, may be implemented in a second form. The second form means a form in which the first internal interface area 112C-2 that is implemented in the vertical direction of the control device 11C-2 in a Y axis direction and the first internal input and output line MIO1 and the second internal input and output line MIO2 that are implemented in the horizontal direction of the control device 11C-2 in the X axis direction are disposed.

In the second form, the first memory controller 121C-42, the first base interface area 121C-52, and the first base TSV area 121C-62 may be sequentially disposed in a first direction D1 from the central area CENTER in which the first internal input and output line MIO1 is disposed. In the second form, the second memory controller 122C-42, the second base interface area 122C-52, and the second base TSV area 122C-62 may be sequentially disposed in the first direction D1 from a second edge area BOTTOM in which the second internal input and output line MIO2 is disposed.

Although not illustrated, in an embodiment, the first area 110C-2 may be disposed in the right area RIGHT of the control device 11C-2 in the X axis. Accordingly, the second area 120C-2 that controls an operation of the memory device 12C-2 is disposed in the left area LEFT of the control device in the X axis. The internal interface area 112C-2, the first internal input and output line MIO1, and the second internal input and output line MIO2 may be connected to implement a network-on-chip (NoC).

FIG. 20 is a block diagram illustrating a construction of the memory device 12C-2 according to an embodiment of the present disclosure.

The memory device 12C-2 may include the first to eighth channels CH1 to CH8, the first core TSV area 210C-2, and the second core TSV area 220C-2.

The first to eighth channels CH1 to CH8 may receive the command CMD and the data DATA by independently performing internal operations. The first to eighth channels CH1 to CH8 may each store the data DATA based on the command CMD after the start of a write operation of an internal operation. The first to eighth channels CH1 to CH8 may each output the data DATA based on the command CMD after the start of a read operation of an internal operation.

The first to fourth channels CH1 to CH4 may be electrically connected to the first core TSV area 210C-2. The first to fourth channels CH1 to CH4 may receive a command CMD and data DATA from the first core TSV area 210C-2. The first to fourth channels CH1 to CH4 may output the data DATA to the first core TSV area 210C-2. The first to fourth channels CH1 to CH4 may each store the data DATA based on the command CMD after the start of a write operation of an internal operation. The first to fourth channels CH1 to CH4 may each output the data DATA based on the command CMD after the start of a read operation of an internal operation. The first to fourth channels CH1 to CH4 may be set as the first group of channels.

The fifth to eighth channels CH5 to CH8 may be electrically connected to the second core TSV area 220C-2. The fifth to eighth channels CH5 to CH8 may receive a command CMD and data DATA from the second core TSV area 220C-2. The fifth to eighth channels CH5 to CH8 may output the data DATA to the second core TSV area 220C-2. The fifth to eighth channels CH5 to CH8 may each store the data DATA based on the command CMD after the start of a write operation of an internal operation. The fifth to eighth channels CH5 to CH8 may each output the data DATA based on the command CMD after the start of a read operation of an internal operation. The fifth to eighth channels CH5 to CH8 may be set as the second group of channels.

The first to fourth channels CH1 to CH4 may be disposed in a central area CENTER of the memory device 12C-2. The fifth to eighth channels CH5 to CH8 may be disposed in a second edge area BOTTOM of the memory device 12C-2.

The first core TSV area 210C-2 may be electrically connected to the first base TSV area 121C-32, 121C-62 of the control device 11C-2. The first core TSV area 210C-2 may receive the command CMD and the data DATA from the first base TSV area 121C-32, 121C-62. The first core TSV area 210C-2 may receive the command CMD and the data DATA through a plurality of TSVs. The first core TSV area 210C-2 may output the command CMD and the data DATA to the first to fourth channels CH1 to CH4. The first core TSV area 210-2 may receive the data DATA from the first to fourth channels CH1 to CH4 and output the data DATA to the first base TSV area 121C-32, 121C-62. The first core TSV area 210C-2 may be disposed in a first direction D1 from the central area CENTER. The first direction D1 may be set as a direction from the central area CENTER to a first edge area TOP. The first edge area TOP may be set as an upper area of the memory device 12C-2 in a Y axis.

The second core TSV area 220C-2 may be electrically connected to the second base TSV area 122C-32, 122C-62 of the control device 11C-2. The second core TSV area 220C-2 may receive the command CMD and the data DATA from the second base TSV area 122C-32, 122C-62. The second core TSV area 220C-2 may receive the command CMD and the data DATA through a plurality of TSVs. The second core TSV area 220C-2 may output the command CMD and the data DATA to the fifth to eighth channels CH5 to CH8. The second core TSV area 220C-2 may receive the data DATA from the fifth to eighth channels CH5 to CH8 and output the data DATA to the second base TSV area 122C-32, 122C-62. The second core TSV area 220C-2 may be disposed in the central area CENTER. The second core TSV area 220C-2 may be disposed in the first direction D1 from the second edge area BOTTOM. The first direction D1 may be set as a direction from the second edge area BOTTOM to the central area CENTER. The second edge area BOTTOM may be set as a lower area of the memory device 12C-2 in the Y axis.

The HBM device 7C according to an embodiment of the present disclosure can prevent a phenomenon in which generated heat is diffused to a memory device because the memory device is not stacked on an area from which the heat is generated due to the input and output of the command CMD and the data DATA. The HBM device 7C according to an embodiment of the present disclosure can facilitate the discharge of heat because a dummy die group is stacked on an area from which the heat is generated due to the input and output of the command CMD and the data DATA.

What is claimed is:

1. A semiconductor system comprising:
a high bandwidth memory (HBM) device comprising a first physical area and a second physical area, configured to input and output first data through a first physical area, and configured to input and output second data through a second physical area;
a first process circuit connected to the first physical area and configured to perform an arithmetic operation by receiving the first data; and
a second process circuit connected to the second physical area and configured to perform the arithmetic operation by receiving the second data,
wherein the first physical area and the second physical area are disposed at a boundary of the HBM device.

2. The semiconductor system of claim 1, wherein the HBM device is connected to the first process circuit and the second process circuit in common.

3. The semiconductor system of claim 2, wherein the HBM device comprises:
a control device comprising first to third areas, wherein the first area inputs and outputs the first data, the second area generates the first data and the second data, and the third area inputs and outputs the second data; and
a memory device vertically stacked on the second area, configured to receive a command from the second area, and configured to input and output the first data and the second data.

4. The semiconductor system of claim 3, wherein the control device comprises:
the first physical area configured to generate the command and configured to input and output the first data;
a first internal interface area electrically connected to the first physical area and an internal input and output line and configured to adjust an input and output sequence of the command and the first data;
a second internal interface area electrically connected to the second physical area and the internal input and output line and configured to adjust an input and output sequence of the second data; and
the second physical area configured to input and output the second data.

5. The semiconductor system of claim 4, wherein:
the control device further comprises a memory controller, a base interface area, and a base TSV area,
the first physical area and the first internal interface area are disposed in the first area,
the internal input and output line, the memory controller, the base interface area, and the base TSV area are disposed in the second area, and
the second internal interface area and the second physical area are disposed in the third area.

6. The semiconductor system of claim 5, wherein:
the internal input and output line is disposed in a central area of the second area of the control device,
the memory controller, the base interface area, and the base TSV area are sequentially disposed in a first direction from the central area, and
the first direction is set as a direction from the central area to an edge area of the control device.

7. The semiconductor system of claim 5, wherein:
the internal input and output line is disposed in an edge area of the second area of the control device,
the memory controller, the base interface area, and the base TSV area are sequentially disposed in a second direction from the edge area, and
the second direction is set as a direction from the edge area to a central area of the control device.

8. The semiconductor system of claim 3, wherein:
the memory device comprises a plurality of channels and a core TSV area, and
the core TSV area receives the command, the first data, and the second data from the control device and outputs the command, the first data, and the second data to the plurality of channels, and receives the first data and the second data from the plurality of channels and outputs the first data and the second data to the control device.

9. The semiconductor system of claim 8, wherein:
the plurality of channels is disposed in a central area of the memory device,
the core TSV area is disposed in a first direction from the central area, and
the first direction is set as a direction from the central area to an edge area of the memory device.

10. The semiconductor system of claim 8, wherein:
the plurality of channels is disposed in an edge area of the memory device,
the core TSV area is disposed in a second direction from the edge area, and
the second direction is set as a direction from the edge area to a central area of the memory device.

11. A semiconductor system comprising:
a first high bandwidth memory (HBM) device comprising a first physical area and configured to input and output first data through the first physical area;
a first process circuit configured to perform an arithmetic operation by receiving the first data through the first physical area and configured to perform the arithmetic operation by receiving second data through a second physical area;
a second HBM device comprising the second physical area and a third physical area, configured to input and output the second data through the second physical area, and configured to input and output third data through the third physical area;
a second process circuit configured to perform an arithmetic operation by receiving the third data through the third physical area and configured to perform the arithmetic operation by receiving fourth data through the fourth physical area; and
a third HBM device comprising the fourth physical area and configured to input and output the fourth data through the fourth physical area,
wherein the first physical area is disposed at a boundary of the first HBM device, the second physical area and the third physical area are disposed at a boundary of the second HBM device, and the fourth physical area is disposed at a boundary of the third HBM device.

12. A semiconductor system comprising:
an internal interface disposed in a first direction (vertical direction), configured to receive a command and data, and configured to output the command and the data; and
an internal input and output line disposed in a second direction (horizontal direction), electrically connected to the internal interface, configured to receive the command and the data from the internal interface, and configured to output the command and the data,
wherein the first direction is substantially orthogonal to the second direction.

13. The semiconductor system of claim 12, further comprising a memory controller disposed in the second direction, electrically connected to the internal input and output line, and configured to control a memory device by receiving the command and the data from the internal input and output line.

14. The semiconductor system of claim 13, wherein the memory controller is disposed in the first direction from the internal input and output line disposed in the second direction.

15. The semiconductor system of claim 13, further comprising:
a base interface area disposed in the second direction, electrically connected to the memory controller and configured to receive and output the command and the data; and
a base TSV area disposed in the second direction, electrically connected to the base interface area, configured to receive the command and the data, and configured to output the command and the data to the memory device.

16. The semiconductor system of claim 15, wherein the memory controller, the base interface area, and the base TSV area are sequentially disposed in the first direction from the internal input and output line.

17. The semiconductor system of claim 15, wherein the memory device comprises a core TSV area disposed in the second direction, electrically connected to the base TSV area, configured to receive the command and the data, and configured to output the command and the data to a plurality of channels.

18. A semiconductor system comprising:
an internal interface disposed in a first direction (vertical direction) and configured to receive and output first and second commands and first and second data;
a first internal input and output line disposed in a second direction (horizontal direction), electrically connected to the internal interface, configured to receive the first command and the first data from the internal interface, and configured to output the first command and the first data; and
a second internal input and output line disposed in the second direction, electrically connected to the internal interface, configured to receive the second command and the second data from the internal interface, and configured to output the second command and the second data,
wherein the first direction is substantially orthogonal to the second direction.

19. The semiconductor system of claim 18, further comprising:
a first memory controller disposed in the second direction, electrically connected to the first internal input and output line, configured to receive the first command and the first data from the first internal input and output line, and configured to output the first command and the first data;
a first base interface area disposed in the second direction, electrically connected to the first memory controller and configured to receive and output the first command and the first data; and
a first base TSV area disposed in the second direction, electrically connected to the first base interface area, configured to receive the first command and the first data, and configured to output the first command and the first data to the first memory device.

20. The semiconductor system of claim 19, wherein the first memory controller, the first base interface area, and the first base TSV area are sequentially disposed in the first direction from the first internal input and output line.

21. The semiconductor system of claim 19, wherein the first memory device comprises:
a first core TSV area disposed in the second direction, electrically connected to the first base TSV area, configured to receive the first command and the first data from the first base TSV area, and configured to output the first command and the first data; and
a first group of channels electrically connected to the first core TSV area and configured to operate by receiving the first command and the first data from the first core TSV area.

22. The semiconductor system of claim 18, further comprising:
a second memory controller disposed in the second direction, electrically connected to the second internal input and output line, configured to receive the second command and the second data from the second internal input and output line, and configured to output the second command and the second data;
a second base interface area disposed in the second direction, electrically connected to the second memory controller, and configured to receive and output the second command and the second data; and
a second base TSV area disposed in the second direction, electrically connected to the second base interface area, configured to receive the second command and the second data, and configured to output the second command and the second data to the second memory device.

23. The semiconductor system of claim 22, wherein the second memory controller, the second base interface area, and the second base TSV area are sequentially disposed in the first direction from the second internal input and output line.

24. The semiconductor system of claim 22, wherein the second memory device comprises:
a second core TSV area disposed in the second direction, electrically connected to the second base TSV area, configured to receive the second command and the second data from the second base TSV area, and configured to output the second command and the second data; and
a second group of channels electrically connected to the second core TSV area and configured to operate by receiving the second command and the second data from the second core TSV area.
